(19) United States
(12) Patent Application Publication
(10) Pub. No.: US 2007/0048531 A1
(43) Pub. Date: Mar. 1, 2007

(54) Hard coating article, curing composition, and information recording media

(75) Inventors: Katsurou Nagaoka, Minami-Ashigara-shi (JP); Akihiro Matsufuji, Minami-Ashigara-shi (JP); Kenichi Fukuda, Minami-Ashigara-shi (JP)

Correspondence Address: BUCHANAN, INGERSOLL & ROONEY PC, POST OFFICE BOX 1404, ALEXANDRIA, VA, 22313-1404, US

(73) Assignee: FUJI PHOTO FILM CO., LTD., Minami-Ashigara-shi (JP)

(21) Appl. No.: 10/574,801

(22) PCT Filed: Oct. 4, 2004
(86) PCT No.: PCT/JP04/14982

§ 371 Date: Apr. 5, 2006

(30) Foreign Application Priority Data
Oct. 6, 2003 (JP) 2003-347111

(51) Int. Cl. B32B 27/00; C08F 2/46; C08L 83/04

(52) U.S. Cl. 428/447; 427/508; 427/515

(57) ABSTRACT

To provide a curing composition suitable for forming an antifouling hard coat layer having high surface hardness, excellent in scratch resistance, and having an antifouling property lasting long; and to provide an optical information recording media having scratch resisting and antifouling properties, and persistent reading characteristics of records, the curing composition includes an actinic energy-curing resin, wherein the actinic energy-curing resin hass a silicone resin having a silicon content of from 23 to 32 weight %; and the optical information recording material has a light-transmitting layer formed by coating and curing the curing composition, wherein a coating amount of the silicone resin is from 0.4 to 45 mg/n².

### TECHNICAL FIELD

The present invention relates to a hard coating article provided with an antifouling hard coat layer and a curing composition to obtain the antifouling hard coat layer. The present invention also relates to an information recording media capable of recording and reproducing by an optical means and a magnetic means, and excellent in antifouling and scratch resisting properties.

### BACKGROUND ART

In recent years, plastic products are replaced with glass products for their processability and light weight, but surfaces of plastic products are susceptible to scratches, therefore, these plastic products are provided with a hard coat layer for providing a scratch resisting property, or laminated with a film having a hard coat layer before use in many cases. Conventionally used glass products are also in many cases laminated with a plastic film for preventing scattering. For reinforcing the hardness of the surface of the film, a hard coat layer is formed on the surface, or for the purpose of improving the surface hardness of a base material, abrasion resistance and antifouling, hard coating articles having a hard coat layer formed on the surface are widely used not only glass products.

Conventionally used hard coat layers are generally manufactured by forming a thin film of from about 3 to 10 μm of a thermosetting resin or an actinic energy-polymerizable resin, e.g., an ultraviolet-curing resin, directly on a base material, or through a primer layer having a thickness of from 0.03 to 0.5 μm or so. However, since hard coat layers so far used are insufficient in hardness or the thickness of a coated film is thin, when the base material is greatly deformed by the load, the hard coat layer also deforms with the deformation of the base material and a crack occurs in the hard coat layer, and so they are not sufficiently satisfactory.

For increasing the hardness of a hard coat layer, a coating composition comprising a polyfunctional acrylic ester monomer as the resin-forming component of a hard coat layer, and containing powdered inorganic filler, e.g., alumina, silica or titanium oxide, and a polymerization initiator is disclosed in Japanese Patent No. 1815116. A photopolymerizable composition containing inorganic filler, e.g., silica or alumina surface-treated with alkoxysilane, etc., is disclosed in Japanese Patent No. 1416240. Further, in recent years, filling crosslinking organic fine particles is discussed. Although these techniques have the effect to increase the surface hardness of hard coat layers, they also have drawbacks such as the increase of haze and the deterioration of brittleness resistance, accordingly not these techniques alone can sufficiently respond to the required performances.

JP-A-2000-52472 (The term “JP-A” as used herein refers to an “unexamined published Japanese patent application”.) proposes a method to satisfy both a curling problem and scratch resistance by using a hard coat layer comprising a two-layer structure and adding silica fine particles to the first layer. Further, a hard coat film comprising a two-layer structure of a hard coat layer is disclosed in JP-A-2000-71392, wherein a curing resin layer comprising a blend of a radical curing resin and a cationic curing resin is used as the lower layer, and a curing resin layer comprising a radical curing resin alone is used as the upper layer. However, these techniques also: cannot obtain sufficient hardness.

On the other hand, it is known that increasing the thickness of a hard coat layer greater than the general thickness of from 3 to 10 μm is effective to reinforce hardness. However, there arise problems that haze increases by thickening a hard coat layer, cracking and peeling are liable to occur due to the deterioration of brittleness resistance and, at the same time, curling of the hard coat film becomes great on account of shrinkage due to hardening.

Accordingly, it is difficult to obtain a practicable hard coat layer having good characteristics by the prior art.

Further, hard coat layers provided on image displays and touch panels for the purpose of protection and prevention of scattering of glass are liable to be soiled with fingerprints, marking pens, cosmetics and sweats by the use, and the soils once adhered are difficult to remove, which impairs the transparency and reflection and results in the lowering of visibility. As the countermeasure of this problem, Japanese Patent No. 3417803 discloses the technique of giving an antifouling property in addition to a hard coat property by providing a hard coat layer comprising a resin composition containing from 0.1 to 100 weight parts of an actinic energy-curing silicone resin per 100 weight parts of polyfunctional acrylate.

However, it has been found that any of the hard coat films disclosed in these patents has drawbacks that the antifouling composition on the surface peels off by the repetition of wiping, so that the antifouling property does not last long, or defects are generated on the surface due to the uneven surface composition. A hard coat film is used, e.g., as the surface protective film of an information recording media, but a film having a defect on the surface, even a minute defect, cannot be used as such a surface protective film, since read out of information is greatly influenced by the defect.

### DISCLOSURE OF THE INVENTION

An object of the present invention is to provide a hard coating article having high surface hardness, excellent in scratch resistance, and having an antifouling property lasting long. Another object of the present invention is to provide a curing composition capable of obtaining an antifouling hard coat layer having high surface hardness, excellent in scratch resistance, and having an antifouling property lasting long.

A still further object of the present invention is to provide an optical information recording media having scratch resisting and antifouling properties, and having persistent reading characteristics of records.

The above objects of the present invention are solved by the following means.

(1) An article comprising a base material and at least one hard coat layer, the at least one hard coat layer comprising an outermost layer of the article,

wherein the outermost layer comprises a cured film formed by coating and curing a curing composition comprising an actinic energy-curing resin, wherein the actinic energy-curing resin comprises a silicone resin having a silicon content of from 23 to 32 weight %; and a coating amount of the silicone resin is from 0.4 to 45 mg/m².

(2) The article as described in item (1), wherein the actinic energy-curing resin further comprises a first curing resin having a first molecule, the first molecule having three or more ethylenicallyally unsaturated groups.

(3) The article as described in item (1), wherein the actinic energy-curing resin further comprises: a first curing resin having a first molecule, the first molecule having three or more ethylenicallyally unsaturated groups; and a second curing resin having a second molecule, the second molecule having three or more ring-opening polymerizable groups in, and

the actinic energy-curing resin has a content of the second resin of from 5 to 40 weight % to the total content of the first resin and the second resin.

(4) The article as described in item (3), wherein the second curing resin is a crosslinkable polymer having a repeating unit represented by formula (1): 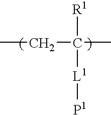
wherein R¹ represents a hydrogen atom or an alkyl group having from 1 to 4 carbon atoms; P¹ represents a monovalent group having a ring-opening polymerizable group; and L¹ represents a single bond or a divalent linking group.

(5) The article as described in item (3) or (4), wherein the three or more ring-opening polymerizable groups comprise a cationic polymerizable group.

(6) The article as described in any one of items (1) to (5), wherein the silicone resin is a polydimethylsiloxane represented by formula (a): 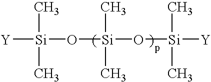
wherein Y represents a hydrogen atom, a methyl group, a hydroxyl group or a methoxy group; p represents an integer of from 10 to 1,500; and 10 to 25% methyl groups are substituted with a alkyl group having a (meth)acrylate group.

(7) The article as claimed in any one of items (1) to (6), wherein the curing composition comprises a particulate filler of from 5 to 35 weight parts to 100 weight parts in total of the actinic energy-curing resin.

(8) The article as claimed in any one of items (1) to (7), wherein the hard coat layer is a single layer.

(9) A curing composition, which comprises an actinic energy-curing resin comprising a silicon resin of from, 0.001 to 0.2 weight % to the total amount of the actinic energy-curing resin, wherein the silicon resin has a silicon content of from 23 to 32 weight %.

(10) An article comprising a base material and at least one hard coat layer, the at least one hard coat layer comprising an outermost layer of the article,

wherein the outermost layer comprises a cured film formed by coating and curing a curing composition as described in item (9) on the base material.

(11) The article as claimed in any one of claims 1 to 8 and 10, wherein the base material is a film having a thickness of from 20 to 300 μm.

(12) An information recording media capable of reproducing an information signal by an optical means, which comprises: a substrate; a recording layer capable of recording the information signal; and a light-transmitting layer capable of transmitting a light in this order,

wherein the light-transmitting layer is an article as described in any one of items (1) to (8), (10) and (11).

(13) The information recording media as described in item (12), wherein the base material is a polycarbonate film having a thickness of from 20 to 300 μm, and the light-transmitting layer has a thickness of from 50 to 300 μm.

According to the present invention, a hard coating article having high surface hardness, excellent in scratch resistance, and having an antifouling property lasting long can be obtained by coating a hard coat layer formed from a curing composition containing a specific silicone resin on the outermost surface of the article in a prescribed coating amount of the silicone resin, and such a hard coating article has wide application in various fields. By using a transparent film as the base material, a transparent base material (a hard coat film) excellent in an antifouling property and scratch resistance can be obtained as a hard coating article. The hard coating articles according to the invention can be used as displays and touch panels of CRT, LCD, PDP and FED, windows of buildings and vehicles, wall materials capable of the prevention of scribblings and sticking of bills, tables, decorative plywood, etc., and they are particularly preferred as the surface protective films of optical information recording medias, e.g., CD, DVD and Blu-ray Disc.

### DETAILED DESCRIPTION OF THE INVENTION

The hard coating articles and the information recording medias in the present invention are described in detail below. In the specification of the present invention, the description “from (numeric value 1) to (numeric value 2)” is the meaning of “(numeric value 1) or more and (numeric value 2) or less”.

The article (or hard coating article) in the invention has a base material and a hard coat layer. The hard coating article in the invention has an outermost layer which is a hard coat layer comprising a hardened film formed from a curing composition. The curing composition contains an actinic energy-curing silicone resin having a silicon content of from 23 to 32 weight %. The present inventors have found that the affinity with curing resins other than silicone-containing resins increases by using the actinic energy-curing silicone resin having the specific silicon content, and the antifouling property of the hard coat layer lasts long.

In the view of an antifouling property, it is preferred that the contact angle of the surface of a hard coat layer to water be 90° or more, or 970 or more. For bringing the contact angle of the surface of a hard coat layer to water to the above range, fluorine atoms and/or silicon atoms are conventionally added to a curing composition to form a hard coat layer.

Of curing resins to be contained in a hard coat layer, as specific examples of curing resins having an actinic energy-polymerizable group and containing a fluorine atom and/or a silicon atom used as the antifouling agent, monomers containing a fluorine atom or a silicon atom, copolymers, block copolymers or graft copolymers of the monomers containing a fluorine atom or a silicon atom wherein an acrylic group is contained are exemplified.

As the monomer containing a silicon atom, a monomer having a siloxane group obtained by the reaction of polydimethylsiloxane and (meth)acrylic acid is exemplified. As the specific examples of siloxane compounds having (meth) acrylate at terminals, X-22-164A, X-22-164B, X-22-164C, X-22-2404, X-22-174D, X-22-8201 and X-22-2426 (manufactured by Shin-Etsu Chemical Co., Ltd.) are exemplified.

Hard coat layers containing these antifouling agents are so far been known, but when these conventional hard coat layers are repeatedly rubbed or wiped with water, a subsequent antifouling property suddenly lowers. According to the analysis of the cause by the present inventors, the cause is due to the fact that conventional antifouling agents contain 34 weight % or more silicon to heighten the initial antifouling property, but these antifouling agents localize on the surface, so that the silicon or fluorine contents on the surface are liable to be reduced after rubbing and wiping with water.

On the contrary, in the present invention, by using an actinic energy-curing silicone resin having specific silicon content, the affinity with the constituting materials of a hard coat layer other than silicon-containing resins increases, and the antifouling property does not lower-and can last long even when the hard coat layer is rubbed or wiped with water.

It is essential that the silicon content in the actinic energy-curing silicone resin used as the antifouling agent in the invention is from 23 to 32 weight %, preferably from 26 to 31 weight %, and most preferably from 29 to 31 weight %. When the silicon content is higher than this range, the silicon localizes on the surface of the resin and the antifouling property does not last, or non-homogeneity of the surface composition is brought about, so that the hard coating article of the invention is not fit for use in particular as the material for display or the protective film of an optical information recording media. While when the content is lower than this range, the contact angle of the surface cannot be made so high as the desired range, so that the antifouling property cannot be exhibited from the initial stage.

The specific examples of the silicon-containing actinic energy-curing silicone resin is dimethylsiloxane derivatives, and in this case, it is essential for the dimethylsiloxane derivatives to contain an actinic energy-polymerizable group that polymerizes with the irradiation of actinic energy ray.

As the actinic energy-polymerizable groups, a radical polymerizable double bond, e.g., an acrylic group, and a cationic polymerizable group, e.g., an epoxy group, are exemplified. A particularly preferred actinic energy-polymerizable group is a radical-polymerizable acrylate group or a methacrylate group, and a radical polymerizable acrylate group is most preferred.

As the polydimethylsiloxane containing an actinic energy-polymerizable group, polydimethylsiloxane represented by formula (a): 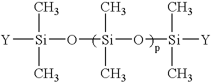
wherein Y represents a hydrogen atom, a methyl group, a hydroxyl group or a methoxy group; p represents an integer of from 10 to 1,500; and 10 to 25% methyl groups are substituted with a alkyl group having a (meth)acrylate group.

The ratio that the methyl groups are substituted with alkyl groups containing a (meth)acrylate group is more preferably from 13 to 22%, and most preferably from 16 to 19%. When the ratio of the (meth)acrylate group is less than this range, the bonding with the constituting materials of a hard coat layer other than silicone resins weakens, so that an antifouling property lowers by rubbing and wiping. While when the ratio of the acrylate group is more than this range, the silicon content cannot be made so high as the desired range, so that the antifouling property cannot be exhibited.

As the alkyl group containing a (meth)acrylate group, a group represented by —(CH₂)_{q}—OCO—C(X)═CH₂ (wherein q represents an integer of from 2 to 8, preferably 3 or 4, and X represents a hydrogen atom or a methyl group) is preferred.

As the actinic energy-curing silicone resin, e.g., UMS-182 (manufactured by Chisso Corporation) can be exemplified. Further, Si content according to the invention can be achieved by arbitrarily varying the polymerization composition ratio and the degree of acrylic modification of, e.g., X-22 or X-24 (manufactured by Shin-Etsu Chemical Co., Ltd.), GS1015 (manufactured by TOAGOSEI CO., LTD.) and UMS-992, RMS-044 or RMS-083 (manufactured by Chisso Corporation).

Polydimethylsiloxane for use in the invention can be synthesized according to the methods disclosed in JP-A-7-70246, JP-A-7-76611, JP-A-9-3392 and JP-A-2001-226487.

The molecular weight of the actinic energy-curing silicone resin can be selected from l,000 to 100, 000, preferably from 2,000 to 10,000, and more preferably from 2,500 to 5,000.

The coating amount of the actinic energy-curing silicone resin is from 0.4 to 45 mg/m², preferably from 1 to 30 mg/m², more preferably from 2 to 20 mg/m², and particularly preferably from 3 to 8 mg/m². When the coating amount is smaller than this range, an antifouling property cannot be sufficiently exhibited, and when the amount is greater than this range, non-homogeneity of the surface composition is brought about, so that the hard coating article of the invention is not fit for use in particular as the material for display or the protective film of an optical information-recording media. The coating amount of the silicone resin can reach the above range by adjusting the use amount of the actinic energy-curing silicone resin in the curing composition for forming a hard coat layer according to the thickness of the hard coat layer to be formed.

The content of the actinic energy-curing silicone resin in the curing composition in the invention is preferably from 0.001 to 0.2 weight % to the total amount of the actinic energy-curing resins for use in the curing composition, more preferably from 0.005 to 0.1 weight %, and most preferably from 0.01 to 0.05 weight %.

In the present invention, the actinic energy-curing silicone resin can be used in combination with a fluorine-containing compound. As the fluorine-containing compounds, perfluoroalkyl group-containing (meth)acrylate typified by hexafluoroisopropyl acrylate, heptadecafluorodecyl acrylate, perfluoroalkylsulfonamide ethyl acrylate and perfluoroalkylamide ethyl acrylate are exemplified. As the specific examples of the compounds, compounds having a polymerizable group, e.g., 2-perfluorooctylethyl methacrylate and 2-perfluorooctylethyl acrylate (manufactured by NIPPON MEKTRON LTD.) , M-3633, M-3833, R-3633 and R-3833 (manufactured by Daikin Fine Chemical Institute), AFC-1000, AFC-2000 and FA-16 (manufactured by Kyoeisha Chemical Co., Ltd.), and Megafac 531A (manufactured by Dainippon Ink and Chemicals Inc.) are exemplified.

It is necessary for the hard coating article in the invention to maintain an antifouling property and, at the same time, to increase the pencil hardness of the surface. Although the optimal value of the pencil hardness of the hard coat layer surface varies according to various uses, such as display materials, building materials, optical information recording medias, etc., 3H or higher is preferred, 4H or higher is more preferred, and 5H or higher is particularly preferred.

Pencil hardness can be obtained with pencils regulated by JIS-S-6006, according to the pencil hardness evaluation method regulated by JIS-K-5400 as the hardness of pencil with which a scratch is not observed with a load of 9.8 N.

For the purpose of heightening the pencil hardness, the curing composition for forming a hard coat layer in the invention preferably contains an actinic energy-curing resin other than a silicone resin. As such a resin, it is preferred to contain a curing resin containing a molecule which has two or more ethylenically unsaturated groups, more preferably a curing resin containing a molecule which has three or more ethylenically unsaturated groups, and it is still more preferred for the curing composition to contain both such a curing resin containing ethylenically unsaturated groups and a curing resin containing a ring-opening polymerizable group at the same time.

In the first place, curing resins having two or more ethylenically unsaturated groups in the same molecule are described-in detail below.

The preferred kinds of ethylenically unsaturated groups are an acryloyl group, a methacryloyl group, a styryl group and a vinyl ether group, and a particularly preferred group is an acryloyl group.

As curing resins having two or more ethylenically unsaturated groups in the same molecule, polyfunctional acrylate monomers having from 2 to 6 acrylic ester groups in the molecule, and oligomers having a molecular weight of from several hundreds to several thousands having several acrylic ester groups in the molecule called urethane acrylate, polyester acrylate and epoxy acrylate can be preferably used.

The specific examples of these curing resins having two or more acrylic groups in the same molecule include polyol polyacrylates, e.g., 1,4-butanediol diacrylate, ethylene glycol diacrylate, trimethylolpropane triacrylate, ditrimethylolpropane tetraacrylate, pentaerythritol triacrylate, pentaerythritol tetraacrylate, dipentaerythritol pentaacrylate, and dipentaerythritol hexaacrylate, and urethane acrylates obtained by the reaction of polyisocyanate and a hydroxyl group-containing acrylate, e.g., hydroxyethyl acrylate.

A curing resin having three or more ethylenically unsaturated groups in the same molecule may be used in combination with a curing resin having one or two ethylenically unsaturated groups (a monomer or an oligomer). As the curing resin having three or more ethylenically unsaturated groups in the same molecule, crosslinking polymers having a repeating unit represented by the following formula (2) can also be preferably used. The crosslinking polymers containing a repeating unit represented by formula (2) are described in detail below.

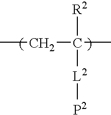

In formula (2), R²represents a hydrogen atom or an alkyl group having from 1 to 4 carbon atoms, preferably a hydrogen atom or a methyl group.

P² represents a monovalent ethylenically unsaturated group or a monovalent group having an ethylenically unsaturated group.

L² represents a single bond or a divalent or higher linking group, preferably a single bond, —O—, an alkylene group, an arylene group, or *—COO—, *—CONH—, *—OCO— or *—NHCO—, wherein the side of * links to the main chain.

P² preferably represents an acryloyl group, a methacryloyl group, a styryl group, or a monovalent group containing any of these groups, and most preferably an acryloyl group or a monovalent group containing an acryloyl group.

The crosslinking polymer containing a repeating unit represented by formula (2) may be synthesized by (i) a method of directly introducing ethylenically unsaturated groups by the polymerization of a corresponding monomer, or (ii) a method of polymerizing a monomer having arbitrary functional groups, and then introducing ethylenically unsaturated groups to the thus-obtained polymer by polymeric reaction. Methods (i) and (ii) may be combined in synthesis. As the polymerization reaction, radical polymerization, cationic polymerization and anionic polymerization are exemplified.

When method (i) is used, synthesis is possible by making use of the difference in polymerizability between the ethylenically unsaturated groups consumed by the polymerization reaction and the ethylenically unsaturated groups left over in the crosslinking polymer. For example, when P² in formula (2) is an acryloyl group, a methacryloyl group, or a monovalent group containing either of these groups, the crosslinking polymer of the invention can be obtained according to method (i) by using cationic polymerization as the polymerization reaction for forming the crosslinking polymer. On the other hand, when P² is a styryl group or a monovalent group containing a styryl group, the crosslinking polymer containing a repeating unit represented by formula (2) is generally synthesized by method (ii), since gelation easily progresses by any methods of radical polymerization, cationic polymerization and anionic polymerization.

Thus, method (ii) utilizing polymeric reaction is capable of obtaining the crosslinking polymer not depending upon the kind of ethylenically unsaturated groups to be introduced to the crosslinking polymer containing a repeating unit represented by formula (2), and so useful.

As the polymeric reaction, (I) a method of forming a polymer containing a functional group as the precursor of an ethylenically unsaturated group, such as eliminating hydrochloric acid from a 2-chloroethyl group, and then inducing the polymer to ethylenically unsaturated group by functional group conversion (elimination reaction, oxidation reaction or reduction reaction), and (II) a method of forming a polymer containing an arbitrary functional group, and then reacting the polymer and a reactive monomer having both an ethylenically unsaturated group and a functional group capable of forming covalent bonding with the functional group in the foregoing polymer by proceeding bond forming reaction are exemplified. These methods (I) and (II) may be performed in combination.

Of the bond forming reactions generally used in the field of organic synthesis, any reaction can be used as the bond forming reaction with no particular restriction so long as the reaction is reaction that forms covalent bonding. Meantime, there are cases where an ethylenically unsaturated group contained in a crosslinking polymer is thermally polymerized during reaction and gels, accordingly it is preferred that the reaction should progress at a possible low temperature (preferably 60° C. or lower, particularly preferably room temperature or lower). Further, a catalyst may be used for the purpose of accelerating the reaction and a polymerization inhibitor may be used with a view to restraining gelation.

The examples of combinations of functional groups by which preferred polymer bond forming reaction progresses are shown below, but the present invention is not limited thereto.

The examples of combinations of functional groups in the case where reaction progresses by heating or at room temperature include:
(a) a hydroxyl group with an epoxy group, an isocyanate group, an N-methylol group, a carboxyl group, an alkyl halide, an acid anhydride, an acid chloride, an active ester group (e.g., a sulfuric ester), a formyl group, or an acetal group,
(b) an isocyanate group with a hydroxyl group, a mercapto group, an amino group, a carboxyl group, or an N-methylol group,
(c) a carboxyl group with an epoxy group, an isocyanate group, an amino group, or an N-methylol group,
(d) an N-methylol group with an isocyanate group, an N-methylol group, a carboxyl group, an amino group, or a hydroxyl group,
(e) an epoxy group with a hydroxyl group, an amino group, a mercapto group, a carboxyl group, or an N-methylol group,
(f) a vinyl sulfone group with a sulfinic acid group or an amino group,
(g) a formyl group with a hydroxyl group, a mercapto group, or an active methylene group,
(h) a mercapto group with a formyl group, a vinyl group (an allyl group, an acrylic group), an epoxy group, an isocyanate group, an N-methylol group, a carboxyl group, an alkyl halide, an acid anhydride, an acid chloride, or an active ester group (e.g., a sulfuric ester),
(i) an amino group with a formyl group, a vinyl group, (an allyl group, an acrylic group), an epoxy group, an isocyanate group, an N-methylol group, a carboxyl group, an alkyl halide, an acid anhydride, an acid chloride, or an active ester group (e.g., a sulfuric ester).

The preferred specific examples of the above reactive monomers are shown below, but the present invention is not limited to these compounds.

Hydroxyl group-containing vinyl monomers (e.g., hydroxyethyl acrylate, hydroxyethyl methacrylate, allyl alcohol, hydroxypropyl acrylate, and hydroxypropyl methacrylate), isocyanate group-containing vinyl monomers (e.g., isocyanate ethyl acrylate and isocyanate ethyl methacrylate), N-methylol group-containing vinyl monomers (e.g., N-methylolacrylamide and N-methylolmethacrylamide)., epoxy group-containing vinyl monomers (e.g., glycidyl acrylate, glycidyl methacrylate, allylglycidyl ether, CYCLOMER-M100 and A200 (manufactured by Daicel Chemical Industries Co., Ltd.)), carboxyl group-containing vinyl monomers (e.g., acrylic acid, methacrylic acid, itaconic acid, carboxyethyl acrylate and vinyl benzoate), alkyl halide-containing vinyl monomers (e.g., chloromethylstyrene and 2-hydroxy-3-chloropropyl methacrylate), acid anhydride-containing vinyl monomers (e.g., maleic anhydride), formyl group-containing vinyl monomers (e.g., acrolein and methacrolein), sulfinic acid group-containing vinyl monomers (e.g., potassium styrenesulfinate), active methylene-containing vinyl monomers (e.g., acetoacetoxyethyl methacrylate), vinyl group-containing vinyl monomers (e.g., allyl methacrylate and allyl acrylate), acid chloride-containing monomers (e.g., acrylic acid chloride and methacrylic acid chloride), and amino group-containing monomers (e.g., allylamine) are exemplified.

The polymers containing arbitrary functional groups described in the above method (II) can be obtained by the polymerization of reactive monomers having both reactive functional groups and ethylenically unsaturated groups. The polymers containing arbitrary functional groups can also be obtained by functional group conversion after polymerization of low reactive precursor monomers, e.g., polyvinyl alcohol that can be obtained by modifying polyvinyl acetate.

As the polymerization method of these compounds, radical polymerization is most simple and preferred.

The preferred specific examples of the repeating units represented by formula (2) are shown below, but the present invention is not limited to these compounds.

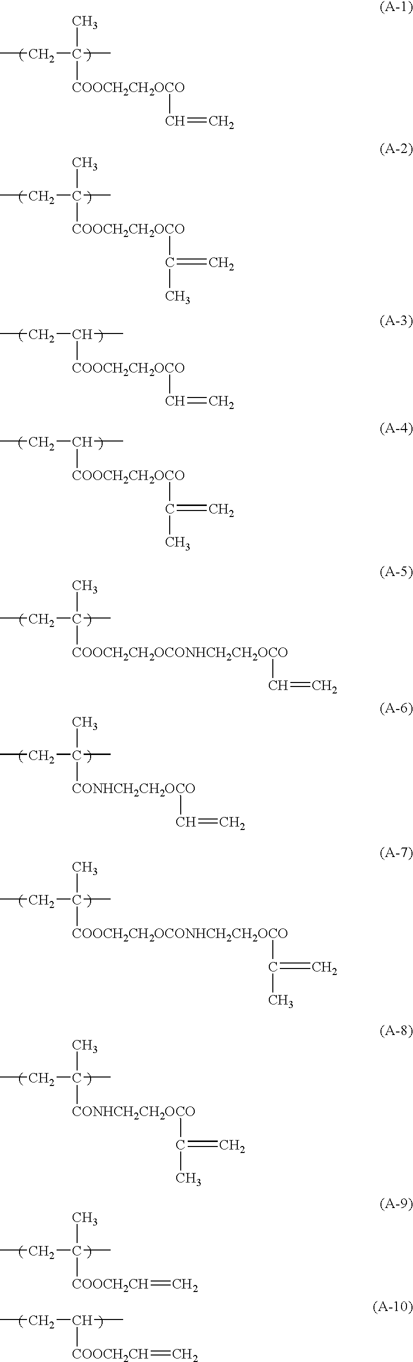

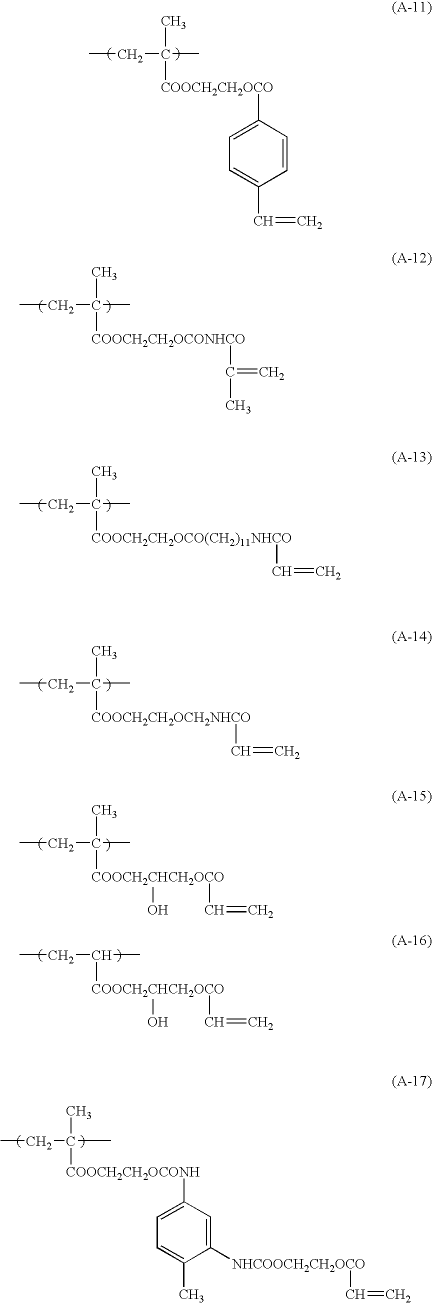

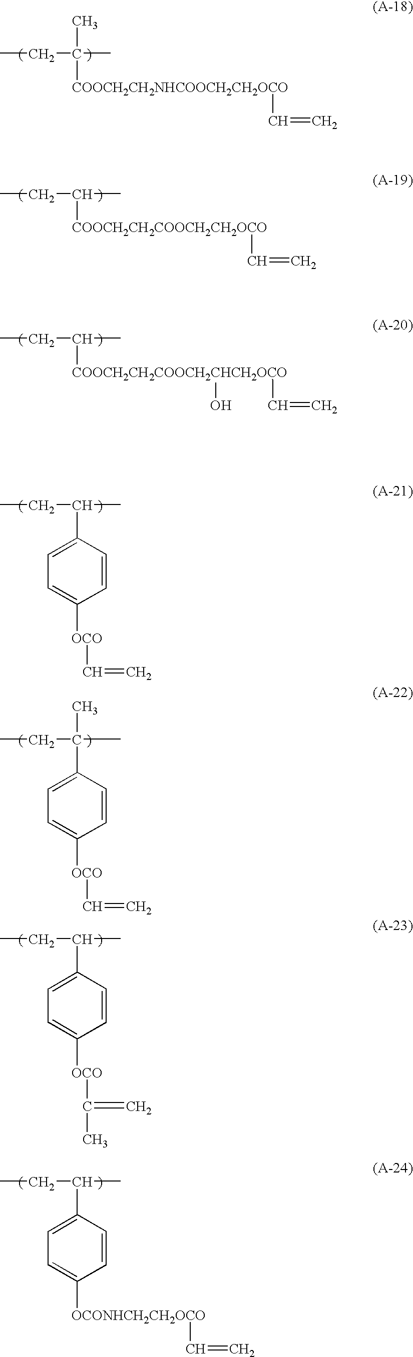

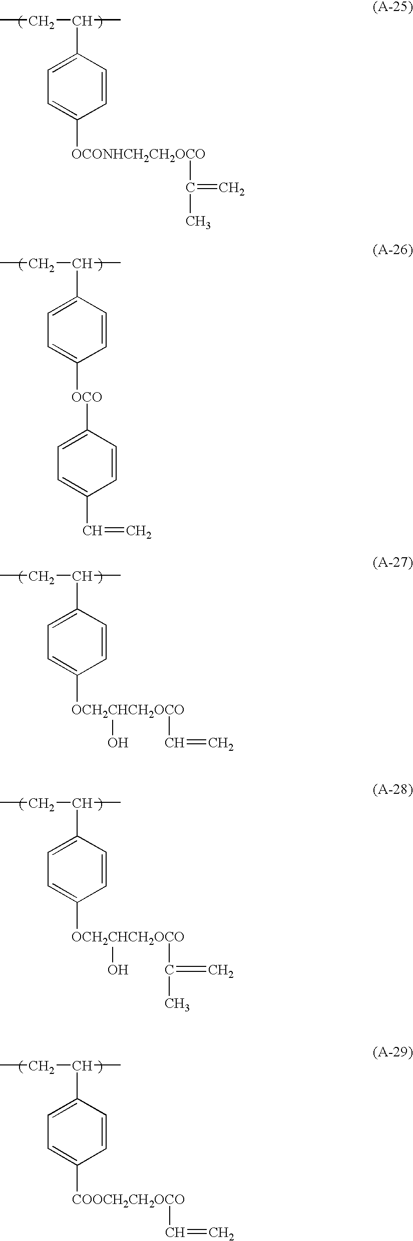

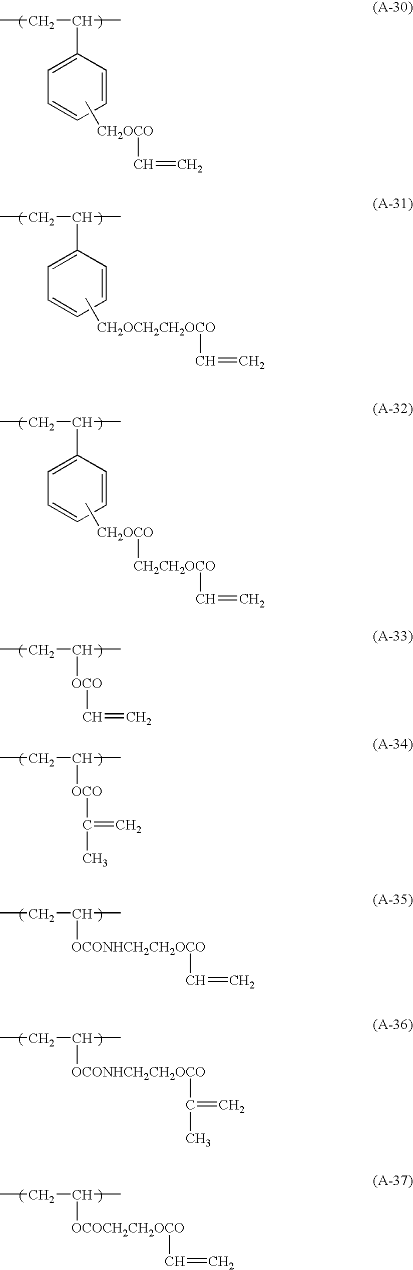

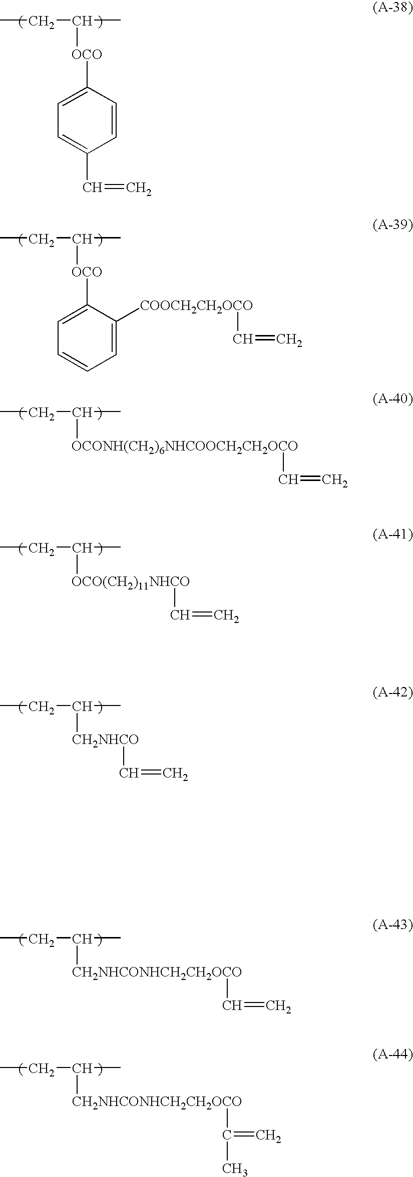

In the invention, a crosslinking polymer containing a repeating unit represented by formula (2) may be a copolymer comprising a plurality of repeating units represented by formula (2), or may be a copolymer containing a repeating unit other than formula (2) (e.g., a repeating unit not containing ethylenically unsaturated groups). In particular, when it is desired to control Tg and the hydrophilicity.hydrophobicity of a crosslinking polymer, or to control the amount of the ethylenically unsaturated groups in a crosslinking polymer, using a copolymer containing a repeating unit other than formula (2) is a preferred means. As the introducing method of a repeating unit other than a repeating unit represented by formula (2), either (a) a method of directly introducing a repeating unit by polymerizing a corresponding monomer, or (b) a method of polymerizing a functional group-convertible precursor monomer and introducing a repeating unit by polymeric reaction, may be used. Methods (a) and (b) may be used in combination in the introduction.

When a repeating unit other than a repeating unit represented by formula (2) is introduced by polymerizing a corresponding vinyl monomer according to method (a), as the preferred monomers, the same monomers as described in formula (1) as the monomers that are preferably used when a repeating unit other than a repeating unit represented by formula (1) is introduced by the polymerization of a corresponding monomer are exemplified. These vinyl monomers may be used in combination of two or more. As the vinyl monomers other than these monomers, the vinyl monomers described in Research Disclosure, No. 19551 (July, 1980) can be used. Of these vinyl monomers, esters and amides derived from acrylic acid or methacrylic acid, and aromatic vinyl compounds are particularly preferably used.

When a repeating unit represented by formula (2) is introduced by polymeric reaction as in method (ii) and the reaction is not completed, it follows that the copolymer has a repeating unit containing functional groups as the precursor of an ethylenically unsaturated groups, or a repeating unit containing reactive functional groups. Such a copolymer can be used in the invention with no limitation.

Almost all the repeating units not containing ethylenically unsaturated groups derived from the above vinyl monomers can also be introduced by method (b) of polymerizing functional group-convertible precursor monomers and then introducing the repeating units to the obtained polymer by polymeric reaction. On the other hand, a crosslinking polymer containing a repeating unit represented by formula (2) may contain a repeating unit other than formula (2) that cannot be introduced in any other way but polymeric reaction. As the typical examples of such repeating units, polyvinyl alcohol obtained by modification of polyvinyl acetate and polyvinyl butyral obtained by acetalization reaction of polyvinyl alcohol are exemplified. The specific examples of these repeating units are shown below, but the present invention is not limited thereto.

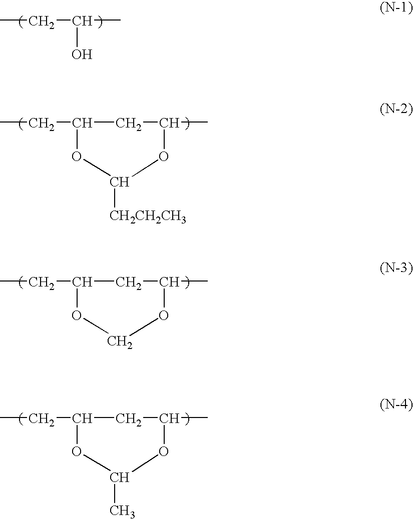

In the invention, in a crosslinking polymer containing a repeating unit represented by formula (2), the ratio of a repeating unit represented by formula (2) being contained is from 1 to 100 weight %, preferably from 30 to 100 weight %, and particularly preferably from 50 to 100 weight %.

The preferred range of number average molecular weight of a crosslinking polymer containing a repeating unit represented by formula (2) (in terms of polyethylene glycol, measured by gel permeation chromatography) is from 1,000 to 1,000,000, more preferably from 3,000 to 200,000, and most preferably from 5,000 to 100,000.

The preferred examples of crosslinking polymers containing a repeating unit represented by formula (2) are shown in Table 1 below, but the present invention is not limited thereto. In Table 1, repeating units represented by formula (2) and repeating units, e.g., polyvinyl alcohol, exemplified above are shown by the formula numbers of exemplification, and the repeating units derived from copolymerizable monomers are shown by the monomer names. Copolymerization composition ratio is shown in weight %.

TABLE 1

| | | Copolymerization |
|---|---|---|
| | | Composition |
| | | Ratio |
| | Constitution of Repeating Unit | (weight %) |
| P-1 | A-1 | 100 |
| P-2 | A-1/n-butylmethacrylate | 60/40 |
| P-3 | A-1/styrene | 80/20 |
| P-4 | A-1/N-t-butylacrylamide | 80/20 |
| P-5 | A-1/butylmethacrylate/ | 38/50/12 |
| | hydroxyethylmethacrylate | |
| P-6 | A-1/A-7/hydroxyethylmethacrylate | 20/67/13 |
| P-7 | A-1/A-9 | 80/20 |
| P-8 | A-1/A-11 | 50/50 |
| P-9 | A-6 | 100 |
| P-10 | A-13 | 100 |
| P-11 | A-14/hydroxyethylmethacrylate | 33/67 |
| P-12 | A-15/methacrylic acid | 87/13 |
| P-13 | A-20/carboxyethylacrylate | 67/33 |
| P-14 | A-21 | 100 |
| P-15 | A-21/N-vinylformamide | 90/10 |
| P-16 | A-25/4-hydroxystyrene | 66/34 |
| P-17 | A-30/chloromethylstyrene/N-phenylmaleimide | 23/27/50 |
| P-18 | A-33/N-1/vinyl acetate | 88/11/1 |
| P-19 | A-37/N-1/vinyl acetate | 93/6/1 |
| P-20 | A-38/N-1/N-2/vinyl acetate | 22/8/69/1 |
| P-21 | A-40/N-1/vinyl acetate | 77/22/1 |

Curing resins containing a ring-opening polymerizable group preferably used in the invention are described below.

Curing resins containing a ring-opening polymerizable group are curing resins having a cyclic structure whose ring-opening polymerization progresses by the actions of cation, anion and radical, and heterocyclic group-containing curing resins are particularly preferred of these curing resins. As such curing resins, cyclic imino ethers, e.g., epoxy derivatives, oxetane derivatives, tetrahydrofuran derivatives, cyclic lactone derivatives, cyclic carbonate derivatives and oxazoline derivatives are exemplified, and epoxy derivatives, oxetane derivatives and oxazoline derivatives are particularly preferred.

In the present invention, two or more curing resins containing a ring-opening polymerizable group may be used in combination. As the curing resins containing a ring-opening polymerizable group, curing resins containing two or more ring-opening polymerizable groups in the same molecule are preferred, and curing resins containing three or more ring-opening polymerizable groups in the same molecule are more preferred. In this case, a curing resin containing one or two ring-opening polymerizable groups in the same molecule and a curing resin containing three or more ring-opening polymerizable groups in the same molecule may be used in combination, or two or more curing resins containing three or more ring-opening polymerizable groups in the same molecule alone may be used in combination.

Curing resins containing ring-opening polymerizable groups for use in the invention are not especially restricted so long as they have the above cyclic structure. The preferred examples of such curing resins include, e.g., monofunctional glycidyl ethers, monofunctional alicyclic epoxies, bifunctional alicyclic epoxies, diglycidyl ethers (e.g., ethylene glycol diglycidyl ether and bisphenol A diglycidyl ether as the glycidyl ethers), trifunctional or higher glycidyl ethers (e.g., trimethylolethane triglycidyl ether, trimethylolpropane triglycidyl ether, glycerol triglycidyl ether, and tris(glycidyloxyethyl)isocyanurate), tetrafunctional or higher glycidyl ethers (e.g., sorbitol tetraglycidyl ether, pentaerythritol tetraglycidyl ether, polyglycidyl ether of cresol novolak resin, and polyglycidyl ether of phenol novolak resin), alicyclic epoxies (e.g., Celloxide 2021P, Celloxide 2081, Epolead GT-301, and Epolead GT-410 (manufactured by Daicel Chemical Industries), EHPE (manufactured by Daicel Chemical Industries), and polycyclohexyl epoxy methyl ether of phenol novolak resin), and oxetanes (OX-SQ and PNOX-1009 (manufactured by TOAGOSEI CO., LTD.)). However, the present invention is not limited thereto.

In the present invention, as the curing resin having a ring-opening polymerizable group, it is particularly preferred to contain a crosslinking polymer containing a repeating unit represented by the following formula (1). The crosslinking polymers are described in detail below.

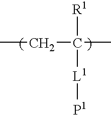

In formula (1), R¹ represents a hydrogen atom or an alkyl group having from 1 to 4 carbon atoms, preferably a hydrogen atom or a methyl group.

L¹ represents a single bond or a divalent or higher linking group, preferably a single bond, —O—, an alkylene group, an arylene group, or *—COO—, *—CONH—, *—OCO— or *—NHCO—, wherein the side of * links to the main chain.

P¹ represents a monovalent ring-opening polymerizable group or a monovalent group having a ring-opening polymerizable group, preferably a monovalent group having an imino ether ring, e.g., an epoxy ring, an oxetane ring, a tetrahydrofuran ring, a lactone ring, a carbonate ring or an oxazoline ring of these groups, a monovalent group having an epoxy ring, an oxetane ring, or an oxazoline ring is particularly preferred.

In the present invention, it is simple and preferred to synthesize a crosslinking polymer containing a repeating unit represented by formula (1) by polymerizing a corresponding monomer. As the polymerization in this case, radical polymerization is most simple and preferred.

The preferred specific examples of the repeating units represented by formula (1) are shown below, but the present invention is not limited to these examples.

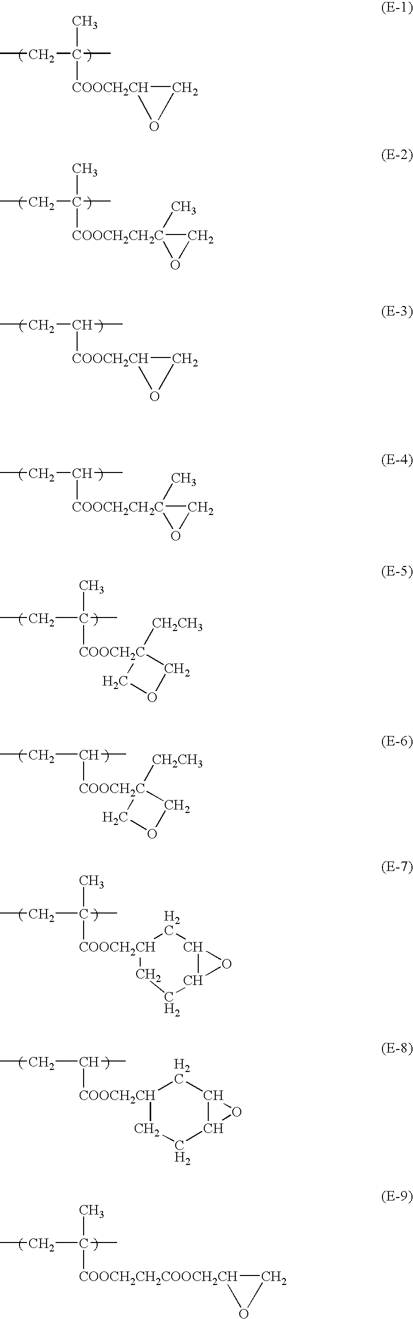

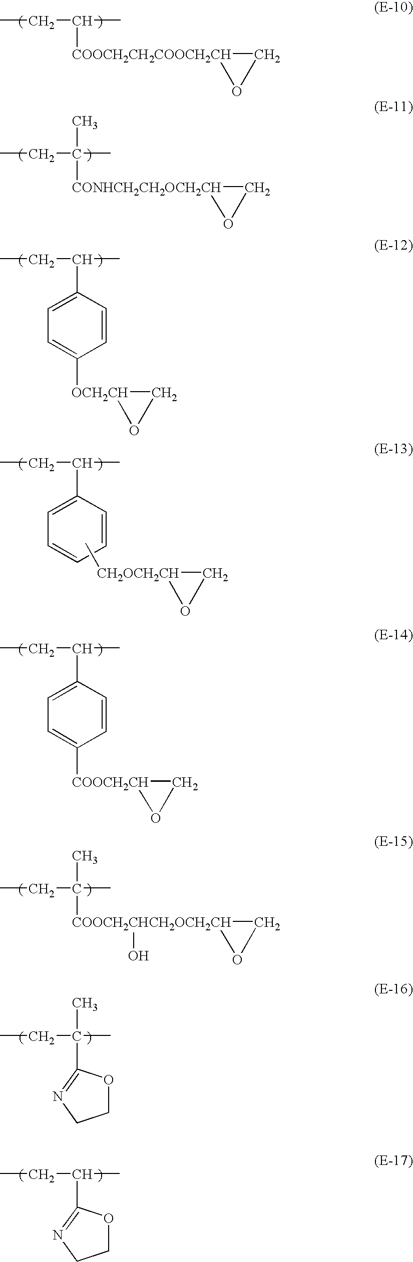

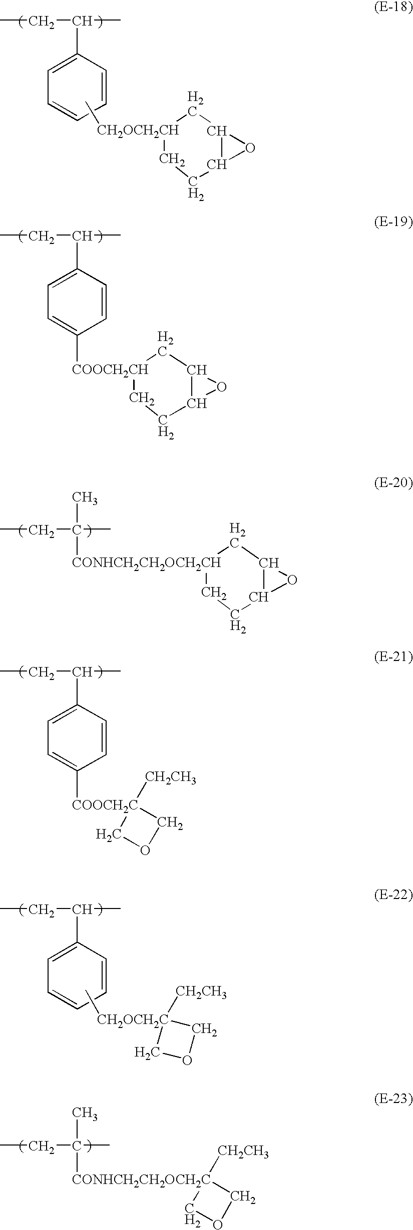

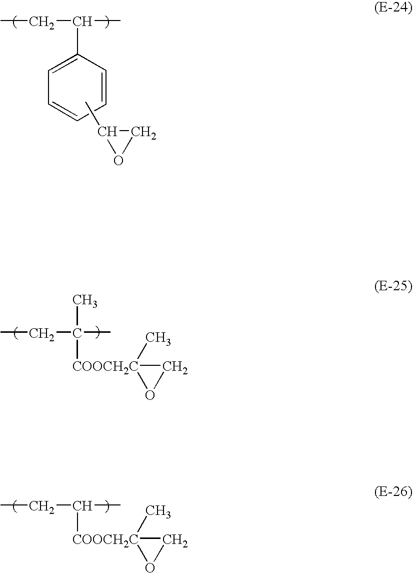

In the invention, a crosslinking polymer containing a repeating unit represented by formula (1) may be a copolymer comprising a plurality of repeating units represented by formula (1), or may be a copolymer containing a repeating unit other than formula (1) (e.g., a repeating unit not containing ring-opening polymerizable groups). In particular, when it is desired to control Tg and the hydrophilicity hydrophobicity of a crosslinking polymer, or to control the amount of the ring-opening polymerizable groups in a crosslinking polymer, to use a copolymer containing a repeating unit other than formula (1) is a preferred means. As the introducing method of a repeating unit other than a repeating unit represented by formula (1), a method of introducing a repeating unit by polymerizing a corresponding monomer is preferred.

When a repeating unit other than a repeating unit represented by formula (1) is introduced by polymerizing a corresponding vinyl monomer, the examples of monomers preferably used include esters derived from acrylic acid or o(-alkylacrylic acid (e.g., methacrylic acid) (e.g., methyl acrylate, ethyl acrylate, hydroxyethyl acrylate, n-propyl acrylate, i-propyl acrylate, 2-hydroxypropyl acrylate, 2-methyl-2-nitropropyl acrylate, n-butyl acrylate, i-butyl acrylate, t-butyl acrylate, t-pentyl acrylate, 2-methoxyethyl acrylate, 2-ethoxyethyl acrylate, 2-methoxymethoxyethyl acrylate, 2,2,2-trifluoroethyl acrylate, 2,2-dimethylbutyl acrylate, 3-methoxybutyl acrylate, ethylcarbitol acrylate, phenoxyethyl acrylate, n-pentyl acrylate, 3-pentyl acrylate, octafluoropentyl acrylate, n-hexyl acrylate, cyclohexyl acrylate, cyclopentyl acrylate, cetyl acrylate, benzyl acrylate, n-octyl acrylate, 2-ethylhexyl acrylate, 4-methyl-2-propylpentyl acrylate, heptadecafluorodecyl acrylate, n-octadecyl acrylate, methyl methacrylate, 2,2,2-trifluoroethyl methacrylate, tetrafluoropropyl methacrylate, hexafluoropropyl methacrylate, hydroxyethyl methacrylate, 2-hydroxypropyl methacrylate, n-butyl methacrylate, i-butyl methacrylate, sec-butyl methacrylate, n-octyl methacrylate, 2-ethylhexyl methacrylate, 2-methoxyethyl methacrylate, 2-ethoxyethyl methacrylate, benzyl methacrylate, heptadecafluorodecyl methacrylate, n-octadecyl methacrylate, 2-isobornyl methacrylate, 2-norbornyl methacrylate, 5-norbornen-2-ylmethyl methacrylate, 3-methyl-2-norbornylmethyl methacrylate, and dimethylaminoethyl methacrylate), amides derived from acrylic acid or α-alkylacrylic acid (e.g., methacrylic acid) (e.g., N-i-propylacrylamide, N-n-butyl-acrylamide, N-t-butylacrylamide, N,N-dimethylacrylamide, N-methylmethacrylamide, acrylamide, 2-acrylamide-2-methyl-propanesulfonic acid, acrylamide propyltrimethylammonium chloride, methacrylamide, diacetoneacrylamide, acryloyl-morpholine, N-methylolacrylamide, and N-methylol-methacrylamide), acrylic acid or α-alkylacrylic acid (e.g., acrylic acid, methacrylic acid, anditaconic acid), vinyl esters (e.g., vinyl acetate), esters derived from maleic acid or fumaric acid (e.g., dimethyl maleate, dibutyl maleate, and diethyl fumarate), maleimides (e.g., N-phenylmaleimide), sodium salts of maleic acid, fumaric acid and p-styrenesulfonic acid, acrylonitrile, methacrylonitrile, dienes (e.g., butadiene, cyclopentadiene, and isoprene), aromatic vinyl compounds (e.g., styrene, p-chlorostyrene, t-butylstyrene, α-methylstyrene, and sodium styrenesulfonate), N-vinyl-pyrrolidone, N-vinyloxazolidone, N-vinylsuccinimide, N-vinylformamide, N-vinyl-N-methylformamide, N-vinyl-acetamide, N-vinyl-N-methylacetamide, 1-vinylimidazole, 4-vinylpyridine, vinylsulfonic acid, sodium vinylsulfonate, sodium allylsulfonate, sodium methallylsulfonate, vinylidene chloride, vinyl alkyl ethers (e.g., methyl vinyl ether), ethylene, propylene, 1-butene and isobutene.

Two or more of these vinyl monomers may be used in combination. As the vinyl monomers other than these monomers, the vinyl monomers described in Research Disclosure, No. 19551 (July, 1980) can be used.

The esters and amides derived from acrylic acid or methacrylic acid, and aromatic vinyl compounds are particularly preferably used.

As the repeating unit other than the repeating unit represented by formula (1), repeating units having a reactive group other than a ring-opening polymerizable group can also be introduced. In particular, when it is desired to heighten the hardness of a hard coat layer, or to improve the adhesion between layers in the case where other functional layer is used on a base material or a hard coat layer, using a copolymer containing a reactive group other than a ring-opening polymerizable group is a preferred means. As the introducing method of a repeating unit having a reactive group other than a ring-opening polymerizable group, a method of polymerizing a corresponding vinyl monomer (a reactive monomer) is simple and preferred.

The specific examples of preferred reactive monomers are shown below, but the present invention is not limited to these examples.

Hydroxyl group-containing vinyl monomers (e.g., hydroxyethyl acrylate, hydroxyethyl methacrylate, allyl alcohol, hydroxypropyl acrylate, and hydroxypropyl methacrylate), isocyanate group-containing vinyl monomers (e.g., isocyanatoethyl acrylate, and isocyanatoethyl methacrylate), N-methylol group-containing vinyl monomers (e.g., N-methylolacrylamide and N-methylolmethacrylamide), carboxyl group-containing vinyl monomers (e.g., acrylic acid, methacrylic acid, itaconic acid, carboxyethyl acrylate and vinylbenzoate), alkyl halide-containing vinyl monomers (e.g., chloromethylstyrene and 2-hydroxy-3-chloropropyl methacrylate), acid anhydride-containing vinyl monomers (e.g., maleic anhydride), formyl group-containing vinyl monomers (e.g., acrolein and methacrolein), sulfinic acid group-containing vinyl monomers (e.g., potassium styrenesulfinate), active methylene-containing vinyl monomers (e.g., acetoacetoxyethyl methacrylate), acid chloride-containing monomers (e.g., acrylic acid chloride and methacrylic acid chloride), amino group-containing monomers (e.g., allylamine), and alkoxysilyl group-containing monomers (e.g., methacryloyloxypropyltrimethoxysilane, and acryloyloxy-propyltrimethoxysilane) are exemplified.

In the invention, in a crosslinking polymer containing a repeating unit represented by formula (1), the ratio of a repeating unit represented by formula (1) being contained is from 1 to 100 weight %, preferably from 30 to 100 weight %, and particularly preferably from 50 to 100 weight %.

The preferred range of number average molecular weight of a crosslinking polymer containing a repeating unit represented by formula (1) (in terms of polyethylene glycol, measured by gel permeation chromatography) is from 1,000 to 1,000,000, more preferably from 3,000 to 200,000, and most preferably from 5,000 to 100,000.

The preferred examples of crosslinking polymers containing a repeating unit represented by formula (1) are shown in Table 2 below, but the present invention is not limited thereto. In Table 2, repeating units represented by formula (1) exemplified above are shown by the formula numbers of exemplification, and the repeating units derived from copolymerizable monomers are shown by the monomer names. Copolymerization composition ratio is shown in weight %.

TABLE 2

| | | Copolymerization |
|---|---|---|
| | | Composition |
| | | Ratio |
| | Constitution of Repeating Unit | (weight %) |
| K-1 | E-1 | 100 |
| K-2 | E-1/n-butylmethacrylate | 60/40 |
| K-3 | E-1/styrene | 80/20 |
| K-4 | E-1/N-t-butylacrylamide | 80/20 |
| K-5 | E-1/butylmethacrylate/ | 40/50/10 |
| | hydroxyethylmethacrylate | |
| K-6 | E-1/methacryloyloxypropyltrimethoxysilane | 70/30 |
| K-7 | E-1/E-5 | 50/50 |
| K-8 | E-1/E-7 | 50/50 |
| K-9 | E-1/E-11 | 80/20 |
| K-10 | E-5/methylmethacrylate | 70/30 |
| K-11 | E-7 | 100 |
| K-12 | E-7/E-17 | 60/40 |
| K-13 | E-13 | 100 |
| K-14 | E-14/E-1 | 67/33 |
| K-15 | E-17 | 100 |
| K-16 | E-18/chloromethylstyrene | 90/10 |
| K-17 | E-19/N-vinylformamide | 66/34 |
| K-18 | E-21/E-3 | 30/70 |
| K-19 | E-22/N-phenylmaleimide | 50/50 |
| K-20 | E-3/vinyl acetate | 90/10 |
| K-21 | E-2 | 100 |

As the curing resins having ring-opening polymerizable groups that can be used in the invention, polymers containing repeating units represented by formula (1) and formula (2) can also be exemplified. The preferred repeating units represented by formulae (1) and (2) in this case are the same as those exemplified above. Further, copolymers containing repeating units other than the copolymners represented by formula (1) and formula (2) and reactive groups other than ethylenically unsaturated groups and ring-opening polymerizable groups can also be used.

In the invention, in a crosslinking polymer containing both repeating units represented by formula (1) and formula (2), the ratio of a repeating unit represented by formula (1) being contained is from 1 to 99 weight %, preferably from 20 to 80 weight %, and particularly preferably from 30 to 70 weight %, and the ratio of a repeating unit represented by formula (2) being contained is from 1 to 99 weight %, preferably from 20 to 80 weight %, and particularly preferably from 30 to 70 weight %.

The preferred range of weight average molecular weight of a crosslinking polymer containing both repeating units represented by formula (1) and formula (2) (in terms of polystyrene, measured by gel permeation chromatography) is from 1,000 to 1,000,000, more preferably from 3,000 to 200,000, and most preferably from 5,000 to 100,000.

The preferred examples of crosslinking polymers containing both repeating units represented by formulae (1) and (2) are shown in Table 3 below, but the present invention is not limited thereto. In Table 3, repeating units represented by formulae (1) and (2) and repeating units, e.g., polyvinyl alcohol, exemplified above are shown by the formula numbers of exemplification, and the repeating units derived from copolymerizable monomers are shown by the monomer names. Copolymerization composition ratio is shown in weight %.

TABLE 3

| | | Copolymerization |
|---|---|---|
| | | Composition |
| | | Ratio |
| | Constitution of Repeating Unit | (weight %) |
| C-1 | A-1/E-1 | 70/30 |
| C-2 | A-1/E-1/n-butylmethacrylate | 60/30/10 |
| C-3 | A-1/E-1/styrene | 40/40/20 |
| C-4 | A-1/E-4/N-t-butylacrylamide | 50/30/20 |
| C-5 | A-1/E-5/E-7 | 40/40/20 |
| C-6 | A-1/A-7/hydroxyethylmethacrylate/E-1 | 30/27/13/30 |
| C-7 | A-1/A-9/E-12 | 60/10/30 |
| C-8 | A-1/A-11/E-17 | 30/50/20 |
| C-9 | A-6/E-5 | 40/60 |
| C-10 | A-15/E-1 | 53/47 |
| C-11 | A-21/E-1 | 35/65 |
| C-12 | A-1/E-7/N-vinylformamide | 60/30/10 |
| C-13 | A-25/E-19 | 60/40 |
| C-14 | A-30/E-14/N-phenylmaleimide | 60/30/10 |
| C-15 | A-33/E-12/N-1/vinyl acetate | 68/20/11/1 |
| C-16 | A-3/A-9/E-12 | 40/30/30 |
| C-17 | A-18/E-5 | 60/40 |
| C-18 | A-29/E-21 | 50/50 |
| C-19 | A-31/E-22 | 65/35 |
| C-20 | A-3/A-6/E-14 | 20/45/35 |

In the present invention, when a curing composition for forming a hard coat layer contains both a curing resin containing three or more ethylenically unsaturated groups in the same molecule and a curing resin containing three or more ring-opening polymerizable groups in the same molecule, the amount of the curing resin containing ring-opening polymerizable groups is preferably from 5 to 40 weight % to the total amount of the curing resin containing ethylenically unsaturated groups and the curing resin containing ring-opening polymerizable groups, more preferably from.10 to 35weight %, andmost preferably from 20 to 30 weight %.

When a curing composition containing a curing resin containing ethylenically unsaturated groups and a curing resin containing ring-opening polymerizable groups. (hereinafter, “a curing composition” is a curing composition containing both of these curing resins unless otherwise indicated) is cured, it is preferred that crosslinking reactions of both curing resins progress. The preferred crosslinking reaction of the ethylenically unsaturated groups is radical polymerization reaction and the preferred crosslinking reaction of the ring-opening polymerizable groups is cationic polymerization reaction. In both cases, polymerization reaction can progress by the actions of actinic energy ray. In general, a small amount of a radical generator called a polymerization initiator and a cation generator (or an acid generator) are added to the reaction system and decomposed by actinic energy ray to generate radical and cation, whereby polymerizations progress. Radical polymerization and cationic polymerization may be carried out separately but it is preferred to progress both polymerizations at the same time.

When the above curing composition is cured by irradiation with actinic energy rays, crosslinking reaction progresses at a low temperature in many cases, which is preferred.

As the actinic energy rays, radiation, γ-rays, α-rays, electron beams and ultraviolet rays are used in the invention. Of these, a method of using ultraviolet rays for curing with ultraviolet rays and adding a polymerization initiator for generating radicals or cations is preferred. Sometimes curing further progresses by heating after irradiation with ultraviolet rays, and this method can also be preferably used. The preferred heating temperature at this time is 140° C. or lower.

As light-acid generating agents to generate cations by ultraviolet rays, ionic curing resins, e.g., triarylsulfonium salts and diaryliodonium salts, and nonionic curing resins, e.g., nitrobenzyl esters of sulfonic acid are exemplified, and various well-known light-acid generating agents, e.g., curing resins described in Imaging yo Yuki Zairyo (Organic Materials for Imaging), compiled by Yuki Electronics Zairyo Kenkyu-kai, published by Bunshin Publishing Co. (1997) can be used. Particularly preferred light-acid generating agents of these are sulfonium salts and iodonium salts, and PF₆⁻, SbF₆⁻, AsF₆⁻and B(C₆F,₅)₄⁻ are preferred as the counter ions.

As the examples of polymerization initiators generating radicals by irradiation with ultraviolet, well-known radical generators, e.g., acetophenones, benzophenones, Michler's ketones, benzoyl benzoate, benzoins, α-acyloxime ester, tetramethylthiuram monosulfide and thioxanthone can be used. Further, sulfonium salts and iodonium salts generally used as light-acid generating agents as described above function also as radical generators by irradiation with ultraviolet, so that they may be used alone in the invention. For the purpose of increasing sensitivity, sensitizers may be used in addition to polymerization initiators, e.g., n-butylamine, triethylamine, tri-n-butylphosphine and thioxanthone derivatives are exemplified as sensitizers.

Polymerization initiators may be used in combination, or curable resins capable of generating both radicals and cations by themselves can be used one kind alone. The addition amount of polymerization initiators is preferably from 0.1 to 15 weight % to the total amount of the curing resins containing ethylenically unsaturated groups and the curing resins containing ring-opening polymerizable groups contained in the curing composition, and more preferably from 1 to 10 weight %.

In using crosslinking polymers containing a repeating unit represented by formula (1) and crosslinking polymers containing a repeating unit represented by formula (2) (hereinafter they are collectively called “the polymers of the invention”), the polymers of the invention are generally solids or highly viscous solutions, so that it is difficult to coat them alone. When the polymers are water-soluble or made aqueous dispersions, aqueous coating can be done but they are generally dissolved in an organic solvent for coating. The organic solvents can be used without particular restriction so long as they can dissolve the polymers of the invention.

As preferred organic solvents, ketones, e.g., methyl ethyl ketone, alcohols, e.g., isopropanol, and esters, e.g., ethyl acetate are exemplified. Further, when the above described monofunctional or polyfunctional polyvinyl monomers and curing resins containing monofunctional, bifunctional, trifunctional or higher ring-opening polymerizable groups are low molecular weight curing resins, it is possible to adjust the viscosity of the curing composition by using them in combination, so that coating can be done without using a solvent.

It is preferred in the invention for the curing composition to contain fine particles as the particle filler. By containing fine particles, it is possible to reduce the shrinking amount due to curing of the hard coat layer, so that the adhesion with the base material is improved or curling can be reduced. As the fine particles, any of inorganic fine particles, organic fine particles and organic-inorganic composite fine particles can be used. As inorganic fine particles, e.g., silicon dioxide particles, titanium dioxide particles, zirconium oxide particles and aluminum oxide particles are exemplified. These inorganic fine particles are generally hard, so that not only shrinkage when cured can be improved but also the hardness of surface can also be improved by filling them in a hard coat layer.

However, since fine particles are generally liable to increase haze, filling methods are adjusted by taking balance of necessary characteristics. In particular, not to increase haze it is necessary that the particle size of fine particles be 200 nm or lower, preferably 100 nm or lower, and most preferably 30 nm or lower.

In general, inorganic fine particles are low in affinity with organic components such as the polymers of the invention and functional vinyl monomers, so that agglomerations are sometimes formed or the hard coat layer is liable to crack after curing if inorganic fine particles are merely mixed. In the present invention, for increasing the affinity of inorganic fine particles and organic components, the surfaces of inorganic fine particles can be processed with a surface modifier containing organic segments. Surface modifiers having functional groups capable of forming bonding with inorganic fine particles or capable of being adsorbed onto inorganic fine particles and functional groups having high affinity with organic components in the same molecule are preferred.

As surface modifiers having functional groups capable bonding to inorganic fine particles or capable of being adsorbed onto inorganic fine particles, metal alkoxide surface modifiers, e.g., silane, aluminum, titanium and zirconium, and surface modifiers having anionic groups, e.g., a phosphoric acid group, a sulfuric acid group, a sulfonic acid group, or a carboxylic acid group are preferred.

As functional groups having high affinity with organic components, functional groups only coinciding hydrophilic and hydrophobic properties with organic components may be used, but functional groups capable of chemically bonding with organic components are preferred, and ethylenically unsaturated groups or ring-opening polymerizable groups are particularly preferred.

Preferred surface modifiers of inorganic fine particles in the invention are curing resins having metal alkoxide or anionic groups and ethylenically unsaturated groups or ring-opening polymerizable groups in the same molecule.

As the representative examples of these surface modifiers, the following shown coupling agents containing an unsaturated double bond, organic curing resins containing a phosphoric acid group, organic curing resins containing a sulfuric acid group, and organic curing resins containing a carboxylic acid group are exemplified.
H₂C═C(X)COOC₃H₆Si(OCH₃)₃ S-1:
H₂C═C(X)COOC₂H₄Oti(OC₂H₅)₃ S-2:
H₂C═C(X)COOC₂H₄OCOC₅H₁₀OPO(OH)₂ S-3:
(H₂C═C(X)COOC₂H₄OCOC₅H₁₀O)₂POOH S-4:
H₂C═C(X)COOC₂H₄OSO₃H S-5:
H₂C═C(X)COO(C₅H₁₀COO)₂H S-6:
H₂C═C(X)COOC₅H₁₀COOH S-7:
3-(Glycidyloxy)propyltrimethoxysilane S-8:

In the above formulae, X represents a hydrogen atom or CH₃.

It is preferred that the surface modification of inorganic fine particles be performed in a solution. When inorganic fine particles are mechanically finely dispersed, a surface modifier maybe present together with inorganic fine particles, a surface modifier may be added and stirred after inorganic fine particles have been finely dispersed, alternatively inorganic fine particles may be subjected to surface modification (if necessary, heating and pH change are carried out after warming and drying), and then finely dispersed.

As the solution for dissolving surface modifiers, organic solvents having a high polarity are preferred, specifically well-known solvents, e.g., alcohols, ketones and esters are exemplified.

Organic fine particles are not especially restricted and polymer particles comprising monomers having ethylenically unsaturated groups, e.g., polymer particles comprising polymethyl methacrylate, polyethyl methacrylate, polyethyl acrylate, polybutyl acrylate, polyethylene, polypropylene, polystyrene, and polymer particles comprising formulae (1) and (2) are preferably used. In addition to the above organic fine particles, resin particles such as polysiloxane, melamine resins, benzoguanamine resins, polytetrafluoroethylene, polycarbonate, nylon, polyvinyl alcohol, polytetrafluoroethylene, polyethylene terephthalate, polyvinyl chloride, acetyl cellulose, nitrocellulose and gelatin are exemplified. It is preferred that these particles are crosslinked.

As the fine dispersers of fine particles, ultrasonic waves, a disper, a homogenizer, a dissolver, a polytron, a paint shaker, a sand grinder, a kneader, an Eiger mill, a Dyno mill, and a co-ball mill are preferably used. Further, the solvents for surface modifiers are preferably used as the dispersants.

The amount of the filler in the curing composition is preferably from 5 to 35 weight parts per 100 weight parts of the actinic energy-curing resins, more preferably from 15 to 35 weight parts, and most preferably from 25 to 30 weight parts.

In the invention, for a hard coat layer to be excellent in scratch resistance, it is preferred that the hardness of the hard coat layer is high to a certain degree. In view of the hardness, the surface elastic modulus of a hard coat layer is preferably about 4.0 GPa or higher, and more preferably 4.5 GPa or higher. When the surface elastic modulus of a hard coat layer is less than 4.0 GPa, sufficient pencil hardness and scratch resistance cannot be obtained. Further, the above surface elastic modulus represented by universal hardness is preferably about 250 N/mm² or higher, and more preferably 300 N/mm² or higher.

The surface elastic modulus can be heightened by the addition of inorganic fine particles. Brittleness resistance lowers as the addition amount of inorganic fine particles increases, so that the upper limit of the surface elastic modulus is 10 GPa, preferably 9.0 GPa. Accordingly, the preferred range of the surface elastic modulus is from 4.0 to 10 GPa, and particularly preferably from 4.5 to 9.0 GPa.

The above surface elastic modulus is a value found with a micro surface hardness meter (Fisher Scope H100VP-HCU, manufactured by Fisher Instruments). This is specifically the elastic modulus obtained by measuring the pushed depth not exceeding 1 μm under a proper test load using a quadrangular pyramid indenter of diamond (tip angle between the opposite faces: 136°), and from the changes of the load and displacement at the time of exclusive of the load.

The surface hardness can also be obtained as the universal hardness with the above micro surface hardness meter. The universal hardness is a value obtained by measuring the pushed depth under a test load using a quadrangular pyramid indenter, and dividing the test load by the surface area of the impression computed from the geometric figure of the impression formed by the test load.

It is known that there is positive correlation between the above surface elastic modulus and the universal hardness.

As a result of examining the compatibility of the pencil hardness and the brittleness of a hard coat layer, a curing composition containing a curing resin containing three or more ethylenically unsaturated groups in the same molecule to which is mixed a curing resin containing three or more ring-opening polymerizable groups in the same molecule has been improved in brittleness, although hardness is a little low. It is effective to coat such a curing composition thick and cure to form a hard coat layer.

From the compatibility of the pencil hardness and brittleness, it is preferred that the thickness of the hard coat layer in the invention is 3 μm or more. If a hard coat layer thickness is too thick, it becomes difficult to bend the film, although the pencil hardness is improved, and cracking is liable to occur when it is tried to further bend the film, so that the thickness of a hard coat layer is preferably 40 μm or less, more preferably 30 μm or less. Accordingly, the thickness of a hard coat layer is preferably from 3 to 40 μm, more preferably from 4 to 30 μm.

In a hard coating article in the invention, a hard coat layer may comprise a single layer or may comprise a plurality of layers. “A single layer” in this case means a hard coat layer formed by curing the same curing composition, and so hard coat layers may be formed by coating and curing of a plurality of times, if the composition after coating and drying is the same. On the other hand, “a plurality of layers” means the layers formed by curing a plurality of curing compositions having different compositions.

In the present invention, when a plurality of hard coat layers are present, an actinic energy-curing silicone resin having a specific silicon content is used in the outermost hard coat layer farthest from the base material as an antifouling agent as described above.

In the present invention, a hard coat layer is preferably a single layer for easiness of manufacture.

A hard coat layer in the invention comprises a hardened film formed by coating a curing composition capable of curing by irradiation with an actinic energy ray, and curing by irradiation with an actinic energy ray. The shrinkage factor by curing of the curing composition by irradiation with an actinic energy ray is preferably from 0 to 15%, more preferably from 0 to 13%, and still more preferably from 0 to 11%.

The shrinkage factor by curing is a value obtained by finding the density of the curing composition before irradiation with an actinic energy ray, e.g., UV ray, and the density of the curing composition after irradiation and curing, and computing from these values according to the following equation A. The densities were measured with MULTIVOLUME PYCNOMETER (manufactured by Micrometric Co.) at 25° C.
Volume shrinkage factor=[1−(density before curing/density after curing)×100 (%) Equation A:

In the present invention, as the curing method of a hard coat layer, the dose of an actinic energy ray, wavelength and the atmosphere of the time of irradiation are important. It is necessary that the wavelength of an actinic energy ray coincide with the absorption wavelength of an initiator, preferably the dose is from 100 to 3,000 mJ/cm², more preferably from 300 to 900 mJ/cm², and most preferably from 500 to 800 mJ/cm².

It is also preferred that the oxygen concentration at the time of irradiation with actinic energy ray is 3% or lower, more preferably 1% or lower, and most preferably 0.3% or lower.

The base material of a hard coating article is not particularly restricted and it is sufficient to use anything according to use. For instance, as the shapes of base materials, there are sheet-like, plate-like and other three-dimensional objects. According to the shapes of base materials, when a sheet-like base material is used, the hard coating article becomes a sheet, when a plate-like base material is used, the hard coating article becomes a plate, and when the base material of other three-dimensional object is used, the hard coating article becomes a three-dimensional object. When a hard coating article has a decorative effect by decorative treatment, and a hard coating article is used for the purpose of decoration by utilizing the decorative effect, the hard coating article becomes a decorative material. If the shape of a decorative material is a sheet, the decorative material is used as a decorative sheet, if the shape is a plate, the decorative material is used as a decorative plate, and if a three-dimensional object, used as a decorative material.

As the materials of base material, resin, paper, fabric, nonwoven fabric, metal and lumber are used.

Specifically, as the materials of a sheet-like base material, resin, paper, fabric, nonwoven fabric, metal and wood are used.

As the resin, e.g., thermoplastic polyester resins, polyolefin resins, acrylic resins, polycarbonate resins, polystyrene, ABS resins, vinyl chloride resins, and polyamide comprising a single or mixture of two or more different kinds of sheets are used as a single layer or a lamination. However, the resins other than vinyl chloride resins are preferred from the environmental problems, such as dioxine. The thickness of base materials (the total thickness in the case of a lamination) is from 20 to 300 μm or so.

As the thermoplastic polyester resins, polyethylene (high density, medium density or low density), polypropylene (isotactic or syndiotactic), polybutene, ethylene-propylene copolymers, ethylene-propylene-butene copolymers, and olefin-series thermoplastic elastomers are used. As the olefin-series thermoplastic elastomers, those obtained by mixing hard segments comprising crystalline polyolefin resins described above and soft segment comprising elastomers such as ethylene-propylene rubber, ethylene-propylene-diene rubber, atactic polypropylene, styrene-butadiene rubber, or hydrogenated styrene-butadiene rubber are preferred. The mixing ratio of a hard segment and a soft segment is soft segment/hard segment of from 5/95 to 40/60 (by weight) and the like are preferred. If necessary, the elastomer component is crosslinked with well-known crosslinking agents, e.g., sulfur or hydrogen peroxide.

As the paper as sheet-like base material, thin paper weighing from 20 to 200 g/m² or so, wood free paper, linter paper and Japanese paper are used. As the fabric and nonwoven fabric, those comprising glass, vinylon and acrylic are used.

As the metals as sheet-like base material, metal foils are used.

As the lumber as sheet-like base material, sliced veneers comprising trees such-as a Japanese cedar, a pine, a hinoki cypress, an oak tree, a lauan, a teak or a. merapee having a thickness of from 50 to 500 μm or so are used.

As the plate-like base materials, a flat board, a crooked plate having an L-shaped cross section, and a curved plate having a thickness thicker than that of a sheet-like base material are used. As the materials, in addition to the materials described in the sheet-like base materials, as lumbers, e.g., a veneer, a plywood, a particle board, a fiber board and a laminated lumber are further used. As materials, non-pottery materials of the ceramic industry, e.g., extrusion cement, slag cement, ALC (aerated lightweight concrete), GRC (glass fiber reinforced concrete), pulp cement, wood chip cement, asbestos cement, calcium silicate, plaster, plaster slag, and mineral materials, e.g., earthenware, chinaware, porcelain, stoneware, glass and ceramics can also be used. Further, laminates comprising the above sheet-like base materials laminated on plate-like base materials can also be used as plate-like base materials.

As the base materials of three dimensional objects, the materials described in the sheet-like base material and plate-like base material can be used. Laminates comprising the above sheet-like base materials laminated on three dimensional base materials can also be used as three dimensional base materials. Other shapes of three dimensional objects are various kinds of three dimensional shapes exclusive of the plate-like shapes.

When hard coat films are formed for sticking on a display, glass and building materials as hard coating articles of the invention, or as the protective film of an optical information recording media, transparent film-like, sheet-like and plate-like plastics can be used as the base materials. Specifically, films and sheets of polyester, e.g., polyethylene terephthalate and polyethylene naphthalate, cellulose resins, e.g., triacetyl cellulose and diacetyl cellulose, polycarbonate, polymethyl methacrylate, polycarbonate, polysulfone, polyether sulfone, polyallylate, and cycloolefin polymers are preferably used. The thickness of films is preferably from 20 to 300 μm, more preferably from 80 to 200 μm. If the thickness of a base material is too thin, the film strength is weak, while when the thickness is too thick, the rigidity becomes too great. The thickness of a sheet should be sufficient in the range not impairing transparency, and a thickness of from 300 μm to several millimeters can be used.

When a hard coating article in the invention is used as a hard coat film, the haze of the hard coat layer is preferably 7% or less, more preferably 5% or less, and most preferably 3% or less. As the evaluation method of haze, the value measured automatically with a turbidimeter “NDH-1001DP” (manufactured by Nippon Denshoku Industries Co., Ltd.) according to haze=(diffused light/all transmitted light)×100 (%) was used.

The value of curl of a hard coat film represented by the following equation B is preferably from −15 to +15, more preferably from -12 to +12, and still more preferably from −10 to +10. The measuring direction of the curl in the sample at this time was the transfer direction of the base material in the case of coating in the form of a web.
Curl=1/R Equation B:
R is radius of curvature (m)

Curling is an important characteristic for the purpose of not generating cracking and film peeling during the manufacture, processing, and handling on the market of a hard coat film. It is preferred that the value of curling is in the above range and curl is small. It is possible to make the curl as small as in the above range and make the surface hardness high by making the volume shrinkage factor before and after curing of the curing composition to form a hard coat layer 15% or lower.

The measurement of curl is performed with the plate for curl measurement of method A in “The Measuring Method of Curl of Photographic Films” of JIS K7619-1988. The conditions of the measurement are 25° C., RH 60%, and humidity conditioning hours of 10 hours.

That the curl is plus means the curl that the coated side of the hard coat layer of a film is the inside of the curve, and minus means the curl that the coated side is the outside of the curve.

When only the relative humidity is changed to 80% and 10% based on the above measuringmethod of the curl, the absolute value of the difference of each value of curling of a hard coat film in the invention is preferably from 24 to 0, more preferably from 15 to 0, and most preferably from 8 to 0. In this range of the curl, good handling property can be obtained when the film is stuck under various humidity conditions, so that cracking and peeling can be prevented and preferred.

When a hard coat film is rolled up with the hard coat layer coated side outside, the cracking resistance of the hard coat film is preferably 50 mm or less as the diameter of curvature of generating cracking, more preferably 40 mm or less, and most preferably 30 mm or less. With respect to the crack at the edge part, it is preferred that no cracking occurs or the length of the crack is less than 1 mm on average. The cracking resistance is an important characteristic for the purpose of not generating cracking defects by handling during coating, processing, cutting and sticking of a hard coat film.

In a hard coating article in the invention, a hard coat layer can be formed by coating an actinic energy-curing solution by various thin film forming methods, e.g., dip coating, spinner coating, spray coating, roll coating, gravure coating, wire bar coating, slot extrusion coating (single layer, multilayer), and slide coating, drying and irradiating with actinic energy rays, whereby curing.

The concentration of solids content in a coating solution is from 3 to 100 weight %, preferably from 20 to 90 weight %, and more preferably from 40 to 80 weight %, and the viscosity of a coating solution is from 1 to 60 cp, preferably from 2 to 40 cp, and more preferably from 3 to 20 cp.

Drying is performed so that the concentration of the organic solvent in the coated solution after drying is preferably 5 weight % or less, more preferably 2 weight % or less, and still more preferably 1 weight % or less. The drying conditions are influenced by the thermal intensity of the base material, the transfer rate and the length of drying process, but the drying temperature is from 35 to 150° C., preferably from 50 to 140° C., and more preferably from 70 to 130° C., and the drying time is from 10 to 10,000 seconds, preferably from 30 to 1, 000 seconds, and more preferably from 60 to 500 seconds. The lower the organic solvent content, the higher is the polymerization rate at curing, which is preferred. The dose of an actinic energy ray is from 50 to 2,000 mJ/cm², preferably from 200 to 1,500 mJ/cm², and more preferably from 400 to 1,000 mJ/cm².

Further, for the purpose of improving the adhesion of a base material and a hard coat layer, if desired, one or both surfaces of a base material can be subjected to surface treatment by oxidation or surface roughening treatment. As the oxidation treatment, e.g., corona discharge treatment, glow discharge treatment, chromic acid treatment (wet treatment), flame treatment, hot air treatment, and irradiation treatment with ozone.UV are exemplified.

Further, one or more undercoat layers can be provided. As the materials of the undercoat layers, copolymers or latexes of, e.g., vinyl chloride, vinylidene chloride, butadiene, (meth)acrylic ester, and vinyl ester, low molecular weight polyester, and water-soluble polymers, e.g., gelatin are exemplified. Further, undercoat layers can contain antistatic agents such as metallic oxides, e.g., tin oxide, compound oxide of tin oxide.antimony oxide, and compound oxide of tin oxide.indium oxide, and quaternary ammonium salt.

When the hard coating article of the invention is a hard coat film to be stuck on a display, glass and building materials, or to be used as the protective film of an optical information recording media, it is preferred to stick the hard coat film on the object through an adhesive layer. In the process of providing an adhesive layer on a hard coat film, the adhesive layer can be provided continuously on the side of the film opposite to the side on which a hard coat layer has been previously provided. The providing method of an adhesive layer can be divided broadly into the following two methods, i.e., a method of sticking a previously provided adhesive layer (hereinafter arbitrarily referred to as the indirect method), and a method of forming an adhesive layer by directly coating an adhesive on the surface of a light transmitting film and drying (hereinafter arbitrarily referred to as the direct method).

“A method of sticking a previously provided adhesive layer” in the case of the indirect method means a method of continuously coating an adhesive on the surface of a releasable film having the same size as the light transmitting film and drying to provide an adhesive layer on the entire surface of one side of the releasable film, and sticking the adhesive layer on the light transmitting film. As a result, an adhesive layer with a releasable film is to be provided on the entire surface of the side opposite to the side having a hard coat layer of the light transmitting film.

The direct method is a method of providing an adhesive layer on the entire surface of the side opposite to the side having a hard coat layer of a light transmitting film by delivering the tip of a hard coat film wound into a roll to the fixed coating zone, coating an adhesive continuously from the tip to the end of the light transmitting film, and successively drying the coated layer.

As the coating means of an adhesive in the direct method and indirect method, well-known coating means can be used. Specifically, spray coating, roll coating, blade coating, doctor roll-coating and screen printing are exemplified.

As the drying means, conventionally well known methods, e.g., heating and air blasting can be used.

As the adhesive, acrylic, rubber and silicone adhesives can be used, but acrylic adhesives are preferred for their transparency and durability. As the acrylic adhesives, it is preferred to use copolymers comprising 2-ethylhexyl acrylate and n-butyl acrylate as the main components with short chain alkyl acrylate and methacrylate, e.g., methyl acrylate, ethyl acrylate and methyl methacrylate for increasing the cohesive force, and acrylic acid, methacrylic acid, acrylamide derivative, maleic acid, hydroxyethyl acrylate, and glycidyl acrylate capable of becoming the crosslinking point with the crosslinking agent. The glass transition temperature (Tg) and the crosslinking density can be changed by arbitrarily controlling the mixing ratio and the kinds of the main component, short chain component and the component for adding crosslinking point.

As the crosslinking agents used in combination with the adhesives, isocyanate crosslinking agents, epoxy resin crosslinking agents, melamine resin crosslinking agents, urea resin crosslinking agents, and chelate crosslinking agents are exemplified, and isocyanate crosslinking agents are more preferred of these crosslinking agents. As isocyanate crosslinking agents, isocyanates, e.g., tolylenediisocyanate, 4,4′-diphenylmethanediisocyanate, hexamethylenediisocyanate, xylylenediisocyanate, naphthylene-1,5-diisocyanate, o-toluidinediisocyanate, isophoronediisocyanate, and triphenylmethanetriisocyanate, and the products of these isocyanates with polyalcohols, and polyisocyanates formed by condensation of isocyanates can be used. As the commercially available products of these isocyanates, Coronate L, Coronate HL, Coronate 2030, Coronate 2031, Millionate MR and Millionate HTL (manufactured by Nippon Polyurethane Industry Co., Ltd.); Takenate D-102, Takenate D-110N, Takenate D-200, Takenate D-202 (manufactured by Takeda Chemical Industries, Ltd.); and Desmodur L, Desmodur IL, Desmodur N, and Desmodur HL (manufactured by Sumitomo Bayer Co., Ltd.) can be exemplified.

An adhesive layer is provided on the side other than the side on which a hard coat layer is provided, and it is preferred that a releasable film is stuck on the surface of the adhesive layer for preventing the adhesion of the hard coat layer and the adhesive layer by winding into a roll in the later process. As described above, a releasable film can be stuck in advance in the indirect method. On the other hand, in the direct method, after an adhesive layer is provided on the surface of a light transmitting film, it is preferred to provide a new process of sticking a releasable film on the surface of the adhesive layer.

As the releasable films to be stuck on the surface of an adhesive layer, a polyethylene film, a polyethylene terephthalate film, a polyethylene naphthalate film, a polycarbonate film, and a cellulose triacetate film are exemplified.

A hard coating article in the invention can be used as the surface protective film of an optical information recording media. Specifically, the optical information recording media (or medium) comprises at least a substrate, a recording layer capable of recording information signals provided on the substrate, and a light-transmitting layer capable of transmitting a light provided on the recording layer, and it is preferred to stick the hard coating article of the invention (preferably a hard coat film) on the recording layer as a light-transmitting layer.

An information recording media in the invention fundamentally comprises a substrate, a recording layer capable of recording information signals provided on the substrate, and a light-transmitting layer capable of transmitting light provided on the recording layer. Each constituent may be replaced with each other or combined in the range not hindering the content of the invention, and it is necessary that every constituent should be present at least one each, but each constituent may comprise a plurality of layers, or may comprise a plurality of layers and one layer of the plurality may have different composition and characteristics. Specifically, two recording layers and light-transmitting layers respectively maybe provided on one side of the substrate such as a substrate/a recording layer/a light-transmitting layer/a recording layer/a light-transmitting layer, or a recording layer and a light-transmitting layer may be provided on both sides of the substrate such as a light-transmitting layer/a recording layer/a substrate/a recording layer/a light-transmitting layer. Besides the above constituents, well-known antistatic layer, lubricating layer, protective layer and reflective layer may be provided. Labels may be printed on the opposite side of the recording layer of the substrate.

An information recording media in the invention may be encased in a cartridge. The size of an information recording media is not limited. In the case of a disc-like information recording media, various sizes may be taken from 30 to 300 mm, e.g., the sizes may be 32, 51, 65, 80, 88, 120, 130, 200 and 300 mm.

In an information recording media in the invention, a substrate is a base having a function of mechanically maintaining the later described recording layer and a light-transmitting layer.

The material of a substrate maybe any of synthetic resins, ceramics and metals. As synthetic resins, various kinds of thermoplastic resins and thermosetting resins, e.g., polycarbonate, polymethyl methacrylate, polystyrene, copolymer of polycarbonate and polystyrene, polyvinyl chloride, alicyclic polyolefin, and polymethylpentene, various actinic energy-curing resins (including UV-curable resins and visible ray-curable resins) can be preferably used. These resins may be synthetic resins blended with metal powders and ceramic powders. As representative ceramics, soda lime glass, soda aluminosilicate glass, borosilicate glass, and quartz glass can be used. As metals, aluminum, copper and iron can be used.

Of these materials, polycarbonate and amorphous polyolefin are preferred from the point of moisture resistance, dimensional stability and inexpensiveness, and polycarbonate is most preferred.

The thickness of a substrate is preferably from 0.3 to 3 mm, more preferably from 0.6 to 2 mm, and most preferably 1.1 mm±0.3 mm.

Grooves for tracking and pre-grooves indicating informations such as address signals are generally formed on the surface of a substrate. It is preferred to form the pre-grooves directly on a substrate in injection molding or extrusion molding a resin material such as polycarbonate.

Pre-grooves may be formed by forming a pre-groove layer. As the materials of the groove layer, mixtures of a monomer (or an oligomer) of at least one of acrylic monoester, diester, triester and tetraester of polyhydric alcohol and a photopolymerization initiator can be used. The pre-groove layer is formed by coating a mixed solution comprising acrylic ester and polymerization initiator on the precisely formed stamper, putting a substrate on the coated layer, and curing the coated layer by irradiation with ultraviolet rays through the substrate or the stamper to cure the coated layer to thereby fix the substrate and the coated layer. The substrate is then released from the stamper, whereby a pre-groove layer is obtained. The thickness of a pre-groove layer is generally from 0.01 to 100 μm, preferably from 0.05 to 50 μm.

In the invention, the track pitch of the pre-grooves of the substrate is preferably from 200 to 400 nm, more preferably from 250 to 350 nm.

The depth of the pre-grooves is preferably from 10 to 150 nm, more preferably from 20 to 100 nm, and still more preferably from 30 to 80 nm. The half value width is preferably from 50 to 250 nm, and more preferably from 100 to 200 nm.

When the later-described light reflecting layer is provided on an information recording media, it is preferred to provide an undercoat layer on the surface of the substrate of the side on which the light reflecting layer is provided for the purpose of improving the plane condition and adhesion.

As the materials of the undercoat layer, polymers, e.g., polymethyl methacrylate, acrylic acid/methacrylic acid copolymer, styrene/maleic anhydride copolymer, polyvinyl alcohol, N-methylolacrylamide, styrene/vinyl toluene copolymer, chlorosulfonated polyethylene, nitrocellulose, polyvinyl chloride, chlorinated polyolefin, polyester, polyimide, vinyl acetate/vinyl chloride copolymer, ethylene/vinyl acetate copolymer, polyethylene, polypropylene, and polycarbonate; and a surface improver, e.g., a silane coupling agent are exemplified.

An undercoat layer can be formed by preparing a coating solution by dissolving or dispersing the above materials in an appropriate solvent, and coating the coating solution on the surface of a substrate by spin coating, dip coating, or extrusion coating. The thickness of an undercoat layer is generally preferably from 0.005 to 20 μm, more preferably from 0.01 to 10 μm.

A light reflecting layer can be provided arbitrarily between a substrate and a recording layer with the intention of improving the reflectance at the time of information reproduction. A light reflecting layer can be provided on a substrate by depositing, sputtering or ion plating light reflecting materials having a high reflectance to laser beams. The thickness of a light reflecting layer is generally from 10 to 300 nm, preferably from 50 to 200 nm. Further, the reflectance of a light reflecting layer is preferably 70% or higher.

As light reflecting materials having a high reflectance, metals, e.g., Mg, Se, Y, Ti, Zr, Hf, V, Nb, Ta, Cr, Mo, W, Mn, Re, Fe, Co, Ni, Ru, Rh, Pd, Ir, Pt, Cu, Ag, Au, Zn, Cd, Al, Ga, In, Si, Ge, Te, Pb, Po, Sn and Bi, semi-metals or stainless steel can be exemplified. These light reflecting materials may be used alone, or two or more may be combined, or may be used as alloys. Of these materials, Cr, Ni, Pt, Cu, Ag, Au, Al and stainless steel are preferred. Au, Ag, Al and alloys of them are particularly preferred, and Au, Ag and alloys of them are most preferred.

In an information recording media in the invention, a recording layer is a layer having a function of capable of information recording and rewriting by recording information signals on the recording layer with an optical or magnetic recording means, and the recording layer is also capable of reproducing information signals from the recording layer by an optical reproducing means (laser beams and the like). When the information recording media is a reproduction-only information recording media, materials having high reflectance are used as the recording layer, and when the information recording media is recording/reproducing type information recording media, the materials of the recording layer are selected from the materials for dye recording, for phase change recording, and for photo-electro-magnetic recording, according to the recording/reproducing principle. The thickness of a recording layer is preferably from2 to 300 nm, and particularly preferably from 5 to 200 nm.

As the light reflecting materials for a recording layer, Au and Ag are used.

As the materials for dye recording, a cyanine dye, a phthalocyanine dye, a naphthalocyanine dye, an azo dye, a naphthoquinone dye, a fulgide dye, a polymethine dye, and an acridine dye can be used.

As the materials for phase change recording, alloys (alloy includes oxide, nitride, carbide, sulfide and fluoride) of indium, antimony, tellurium, selenium, germanium, bismuth, vanadium, gallium, platinum, gold, silver, copper, tin, and arsenic can be used, and GeSbTe, AgInSbTe and CuAlTeSb are particularly preferably used. A laminated layer of an indium alloy and a tellurium alloy may be used as a recording layer.

As the materials for photo-electro-magnetic recording, alloys (alloy includes oxide, nitride, carbide, sulfide and fluoride) of terbium, cobalt, iron, gadolinium, chromium, neodymium, dysprosium, bismuth, palladium, samarium, holmium, ploseodymium, manganese, titanium, palladium, erbium, ytterbium, ruthenium, and tin can be used, and alloys comprising transition metals and rare earth metals represented by TbFeCo, GdFeCo and DyFeCo are particularly preferably used. A recording layer may be formed of alternate lamination of cobalt and platinum.

For the purpose of improving reproduction output, rewriting time and storage stability, an auxiliary film, e.g., alloys of zirconium, tantalum, zinc, magnesium, calcium, aluminum, chromium and zirconium (including oxides, nitrides and carbides) and a high reflection film (aluminum, gold, silver) may be laminated on a recording layer.

When the recording materials for dye recording are used in a recording layer, it is preferred for a recording layer to contain dyes having the absorption maximum in the wavelength region of the laser beams used in reproduction, and it is more preferred to contain dyes having the absorption maximum in the wavelength region of 500 nm or lower, so as to be capable of recording and reproducing in the wavelength region. The dyes to be used are, e.g., a cyanine dye, an oxonol dye, a metal complex dye, an azo dye, and a phthalocyanine dye. Specifically, the dyes disclosed in JP-A-7-74690, JP-A-8-127174, JP-A-11-53758, JP-A-11-334204, JP-A-11-334205, JP-A-11-334206, JP-A-11-334207, JP-A-2000-43423, JP-A-2000-108513, and JP-A-2000-158818 are exemplified, in addition, the dyes such as triazole, triazine, cyanine, merocyanine, aminobutadiene, phthalocyanine, cinnamic acid, viologen, azo, oxonol, benzoxazole and benzotriazole are exemplified, and cyanine, aminobutadiene, benzotriazole and phthalocyanine dyes are preferred.

When the recording materials for dye recording are used, a recording layer can be formed by preparing a coating solution by dissolving the above dyes and, if desired, a binder, in an appropriate solvent, and coating the coating solution on the surface of the above pre-groove of the substrate or on the surface of the light reflecting layer to form a film and drying. Further, the coating solution can contain various additives such as an antioxidant, a UV absorber, a plasticizer and a lubricant according to purpose.

For dissolving and processing the dyes and binder, ultrasonic wave treatment, homogenizer treatment, disper treatment, sand mill treatment, and stirrer treatment can be appropriately used.

As the examples of the solvents for the coating solution, ester, e.g., butyl acetate and cellosolve acetate; ketone, e.g., methyl ethyl ketone, cyclohexanone, and methyl isobutyl ketone; chlorinated hydrocarbon, e.g., dichloro methane, 1,2-dichloroethane and chloroform; amide, e.g., dimethylformamide; hydrocarbon, e.g., cyclohexane; ether, e.g., tetrahydrofuran, ethyl ether and dioxane; alcohol, e.g., ethanol, n-propanol, isopropanol, n-butanol, and diacetone alcohol; a fluorine solvent, e.g., 2,2,3,3-tetrafluoropropanol; and glycol ether, e.g., ethylene glycol monomethyl ether, ethylene glycol monoethyl ether, and propylene glycol monomethyl ether. These solvents may be used alone or two or more solvents can be used in combination, considering the solubility of the dyes and binders to be used.

As the binders, natural organic high molecular substances, e.g., gelatin, cellulose derivative, dextran, rosin, and rubber; synthetic organic polymers, such as hydrocarbon resins, e.g., polyurethane, polyethylene, polypropylene, polystyrene and polyisobutylene, vinyl resin, e.g., polyvinyl chloride, polyvinylidene chloride, and polyvinyl chloride/polyvinyl acetate copolymer, acrylic resin, e.g., polymethyl acrylate and polymethyl methacrylate, and initial condensation products of thermosetting resins, e.g., polyvinyl alcohol, chlorinated polyethylene, epoxy resin, butyral resin, rubber derivative, and phenol/formaldehyde resin are exemplified. When a binder is used in combination as the material of a recording layer, the use amount of the binder is preferably from 0.01 to 50 times (by weight) the dye, more preferably from 0.1 to 5 times. By adding a binder to a recording layer, the storage stability of the recording layer can also be improved.

The concentration of dye in the thus-prepared coating solution is generally from 0.01 to 10 weight %, preferably from 0.1 to 5 weight %.

Spray coating, spin coating, dip coating, roll coating, blade coating, doctor roll coating, and screen printing can be used for coating.

The coating temperature is sufficient at 23 to 50° C., preferably from 24 to 50° C., and more preferably from 25 to 37° C.

A recording layer may be a single layer or multilayer. The thickness of a recording layer is generally from 20 to 500 nm, preferably from 50 to 300 nm.

For improving the light fastness of a recording layer, various kinds of discoloration inhibitors can be used.

As the discoloration inhibitor, a singlet oxygen quencher is generally used. The singlet oxygen quenchers described in well-known publications, e.g., patent specifications can be used. As the specific examples, the compounds described, e.g., in JP-A-58-175693, JP-A-59-81.194, JP-A-60-18387, JP-A-60-19586, JP-A-60-19587, JP-A-60-35054, JP-A-60-36190, JP-A-60-36191, JP-A-60-44554, JP-A-60-44555, JP-A-60-44389, JP-A-60-44390, JP-A-60-54892, JP-A-60-47069, JP-A-63-209995, JP-A-4-25492, JP-B-1-38680 (the term “JP-B” as used herein refers to an “examined Japanese patent publication”), JP-B-6-26028, German Patent 350,399, and Nippon Kagaku-Kai Shi, p. 1141, October, 1992 can be exemplified.

The use amount of discoloration inhibitors such as a singlet oxygen quencher is generally from 0.1 to 50 weight % in the total solids content in an image-recording layer, prefereably from 0.5 to 45 weight %, more preferably from 3 to 40 weight %, and particularly preferably from 5 to 25 weight %.

For the purpose of increasing the adhesion with a light-transmitting layer and the storage stability of dyes, an intermediate layer (a barrier layer) may be provided on the surface of a recording layer. The barrier layer is a layer comprising materials such as oxide, nitride, carbide and sulfide comprising any one or more atoms of Zn, Si, Ti, Te, Sm, Mo and Ge. The barrier layer may a hybrid such as ZnS—SiO₂. The barrier layer can be formed according to sputtering and deposition ion plating, and the thickness is preferably from 1 to 100 nm.

In an information recording media in the invention, a light-transmitting layer has physically a function of introducing convergent regenerating light to a recording layer, at the same time, protecting a recording layer chemically and mechanically and has a hard coating article. A light-transmitting layer in the invention preferably comprises a film thinner than the thickness of a substrate.

“Light transmitting” used in the invention means to be actually transparent (transmittance of 70% or more, preferably 80% or more) to the wavelength of light of the optical means used for recording and reproducing (e.g., rays of from 600 to 800 nm or from 350 to 450 nm).

It is preferred for a light-transmitting layer in the present invention to have a light transmitting film having a moisture expansion coefficient of from 8 to 60 ppm/% RH. When a moisture expansion coefficient is out of the above range, the recording and reproducing aptitude lowers according to the environmental change, and there are cases where recording and reproducing stability decreases. A moisture expansion coefficient is more preferably from 8 to 50 ppm/% RH, and still more preferably from 8 to 40 ppm/% RH.

In the present invention, a moisture expansion coefficient means the rate of dimensional change of a film by the change of environment from 25° C. 20% RH to 25° C. 80% RH. That is, taking the size of a film at 25° C. 20% RH as L₂₀ and the size at 25° C. 80% RH as L₈₀, [(L₈₀−L₂₀)/L₂₀]/(80−20)×10⁶ is the moisture expansion coefficient of the film (unit: ppm/% RH). For example, a moisture expansion coefficient can be obtained by cutting a film to a rectangle of a width of 5 cm and a length of 28 cm, and measuring the lengths of the film at 25° C. 20% RH and at 25° C. 80% RH.

The light transmitting film for use in the invention is preferably not manufactured by stretching. When manufactured by stretching, there is a case where optical anisotropy is caused in the stretching direction, which is not preferred for the light transmitting film of an optical information recording media.

It is preferred that the hard coating article of the light transmitting film of an optical information recording media in the invention has the above light transmitting film as the base material and provides the same hard coat layer as the light transmitting film.

When a hard coat layer of the invention is coated on a film, a film comprising polycarbonate, polyethylene terephthalate, cellulose derivative (in particular, cellulose acylate) or cyclic polyolefin, or polymethyl methacrylic acid is preferably used.

Particularly when a hard coat layer is used as the light-transmitting layer of an optical information recording media, polycarbonate or cyclic polyolefin is preferred and polycarbonate is most preferred.

The thickness of the light-transmitting layer of an information recording media in the invention is preferably thinner than the thickness of the substrate. Considering the aberration that increases when the information recording media is inclined, the thickness is preferably from 50 to 300 μm, more preferably from 60 to 200 μm, and still more preferably from 70 to 120 μm. The fluctuation of the thickness in a single plane is ±3 μm at the maximum, preferably ±2 μm or less, and more preferably ±1 μm or less.

Recording and reproducing of information with an optical information recording media is performed as follows. Rays for recording, e.g., bluish violet laser beams (e.g., wavelength of 405 nm), are radiated from the light-transmitting layer side through an object lens with rotating the optical information recording media at a prescribed linear velocity (from 0.5 to 10 m/sec) or at a prescribed rated speed. The recording layer absorbs the radiated light and the temperature increases locally, by which pits are formed on the recording layer, for instance, to change the optical characteristics, whereby information is recorded. The thus-recorded information is reproduced by radiating bluish violet laser beams as the optical means from the light-transmitting layer side with rotating the optical information recording media at a prescribed linear velocity, and detecting the reflected light.

As the laser light sources having the oscillation wavelength of 500 nm or less as recording and reproducing means, e.g., a bluish violet semiconductor laser having the oscillation wavelength of from 390 to 415 nm, and a bluish violet SHG laser having the central oscillation wavelength of 425 nm can be exemplified.

For increasing recording density, NA or the object lens used for pickup is preferably 0.7or higher, and more preferably 0.85 or higher.

### EXAMPLE

The present invention is described in further detail below with reference to examples, however the present invention is not limited thereto.

### Example 1

Coating on Wooden Base M material:

1-1. Preparation of Hard Coat Layer Coating Solution

(1) Preparation of h-1 Solution

Glycidyl methacrylate was dissolved in methyl ethyl ketone (MEK), and the solution was subjected to reaction at 80° C. for 2 hours while dripping a thermal polymerization initiator V-65 (manufactured by wako Pure Chemical Industries). The obtained reaction solution was dripped into hexane, and the precipitate was dried under reduced pressure, whereby polyglycidyl methacrylate (Compound E-1, the molecular weight in terms of polystyrene: 12,000) was obtained. Compound E-1 was dissolved in methyl ethyl ketone so that the concentration became 50 weight %. To 100 weight parts of the above solution was mixed, with stirring, a solution obtained by dissolving 150 weight parts of trimethylolpropane triacrylate (TMPTA, Viscote #295, manufactured by Osaka Organic Chemical Industry Ltd.) (containing 25 weight % of Epoxy Compound E-1 to the sum total of Compound E-1 and TMPTA), 6 weight parts of photo-radical polymerization initiator (Irgacure 184, manufactured by Ciba Geigy A.G.) (4 weight % to the radical polymerization monomer), 6 weight parts of photo-cationic polymerization initiator (Rhodsil 2074, manufactured by Rhodia Co.) (12 weight % to the cationic polymerization monomer), and 10 weight parts of Megafac 531A (manuffactured by Dainippon Ink and Chemicals Inc.) (20 weight % to the cationic polymerization monomer) in 30 weight parts of methyl isobutyl ketone, whereby hard coat solution h-1 was prepared.

(2) Preparation of Other Solutions

Hard coat solution h-2 was prepared by adding 0.02weight % of acryloxypropylmethylsiloxane-dimethylsiloxane copolymer (UMS-182, manufactured by Chisso Corporation) as Si compound (antifouling agent) to solution h-1.

Acryloxypropylmethylsiloxane-dimethylsiloxane copolymer UMS-182 (manufactured by Chisso Corporation) was added to solution h-14, and X-22-164B (manufactured by Shin-Etsu Chemical Co., Ltd.) was added to solution h-20.

In addition, hard coat solutions h-2 to h-36 as shown in Table 4 below were prepared by changing the kind and addition amount of Si compound.

TABLE 4

| | | | | | | | Antifouling Agent (dimethylsiloxane derivative) | | | | | | | |
|---|---|---|---|---|---|---|---|---|---|---|---|---|---|---|
| | | | | | Fine Particle | | | | Acrylic | | | | | |
| | | | Epoxy Monomer | | Filler | | | Si | Substi- | | | Si Cpd. | Si Atom | Layer |
| Hard | | | | Amount | | Amount | | Con- | tution | | Add. | Coating | Coating | Thick- |
| Coat | | Acrylic | | Used | | Used | Struc- | tent | Rate | Mol. | Amt. | Amount | Amount | ness |
| Soln. | Remarks | Monomer | Structure | (%) | Kind | (%) | ture | (%) | (%) | Weight | (%) | (mg/m²) | (mg/m²) | (μm) |
| h-1 | Comparison | TMPTA | Compound E-1 | 25 | — | — | — | — | — | — | — | 0.0 | 0.0 | 35 |
| h-2 | Invention | TMPTA | Compound E-1 | 25 | — | — | A | 30.5 | 18 | 3,500 | 0.0200 | 7.0 | 2.1 | 35 |
| h-3 | Invention | TMPTA | Compound E-1 | 32 | — | — | A | 30.5 | 18 | 3,500 | 0.0200 | 7.0 | 2.1 | 35 |
| h-4 | Invention | TMPTA | Compound E-1 | 45 | — | — | A | 30.5 | 18 | 3,500 | 0.0200 | 7.0 | 2.1 | 35 |
| h-5 | Invention | TMPTA | Compound E-1 | 18 | — | — | A | 30.5 | 18 | 3,500 | 0.0200 | 7.0 | 2.1 | 35 |
| h-6 | Invention | TMPTA | Compound E-1 | 8 | — | — | A | 30.5 | 18 | 3,500 | 0.0200 | 7.0 | 2.1 | 35 |
| h-7 | Invention | TMPTA | Compound E-1 | 0 | — | — | A | 30.5 | 18 | 3,500 | 0.0200 | 7.0 | 2.1 | 35 |
| h-8 | Invention | TMPTA | Compound E-1 | 8 | — | — | A | 30.5 | 18 | 3,500 | 0.0200 | 3.4 | 1.0 | 17 |
| h-9 | Invention | TMPTA | Compound E-1 | 8 | — | — | A | 30.5 | 18 | 3,500 | 0.0200 | 1.6 | 0.5 | 8 |
| h-10 | Invention | TMPTA | Compound E-1 | 8 | SiO₂ | 15 | A | 30.5 | 18 | 3,500 | 0.0200 | 1.6 | 0.5 | 8 |
| h-11 | Invention | TMPTA | Compound E-1 | 8 | SiO₂ | 30 | A | 30.5 | 18 | 3,500 | 0.0200 | 1.6 | 0.5 | 8 |
| h-12 | Invention | BDDA | Compound E-1 | 25 | — | — | A | 30.5 | 18 | 3,500 | 0.0200 | 7.0 | 2.1 | 35 |
| h-13 | Comparison | TMPTA | Compound E-1 | 25 | — | — | B | 37.2 | 2 | 10,000 | 0.0200 | 7.0 | 2.6 | 35 |
| h-14 | Comparison | TMPTA | Compound E-1 | 25 | — | — | A | 17.1 | 1 | 3,500 | 0.0200 | 7.0 | 1.2 | 35 |
| h-15 | Invention | TMPTA | Compound E-7 | 25 | — | — | A | 30.5 | 18 | 3,500 | 0.0200 | 7.0 | 2.1 | 35 |
| h-16 | Invention | TMPTA | Compound | 25 | — | — | A | 30.5 | 18 | 3,500 | 0.0200 | 7.0 | 2.1 | 35 |
| | | | E-21 | | | | | | | | | | | |
| h-17 | Invention | TMPTA | Comparative | 25 | — | — | A | 30.5 | 18 | 3,500 | 0.0200 | 7.0 | 2.1 | 35 |
| | | | Compound E | | | | | | | | | | | |
| h-18 | Invention | DPHA | — | — | SiO₂ | 30 | A | 30.5 | 18 | 3,500 | 0.0200 | 7.0 | 2.1 | 35 |
| h-19 | Comparison | DPHA | — | — | SiO₂ | 30 | B | 36.1 | 3 | 5,500 | 0.0200 | 7.0 | 2.5 | 35 |
| h-20 | Comparison | DPHA | — | — | SiO₂ | 30 | B | 33.9 | 9 | 1,900 | 0.0200 | 7.0 | 2.4 | 35 |
| h-21 | Comparison | DPHA | — | — | SiO₂ | 30 | B | 37.2 | 2 | 10,000 | 0.0200 | 7.0 | 2.6 | 35 |
| h-22 | Comparison | DPHA | — | — | SiO₂ | 30 | A | 17.1 | 1 | 3,500 | 0.0200 | 7.0 | 1.2 | 35 |
| h-23 | Invention | DPHA | — | — | SiO₂ | 30 | A | 30.5 | 18 | 3,500 | 0.0080 | 2.8 | 0.9 | 35 |
| h-24 | Invention | DPHA | — | — | SiO₂ | 30 | A | 30.5 | 18 | 3,500 | 0.0030 | 1.1 | 0.3 | 35 |
| h-25 | Comparison | DPHA | — | — | SiO₂ | 30 | A | 30.5 | 18 | 3,500 | 0.0009 | 0.3 | 0.1 | 35 |
| h-26 | Comparison | DPHA | — | — | SiO₂ | 30 | — | — | — | — | — | 0.0 | 0.0 | 35 |
| h-27 | Invention | DPHA | — | — | SiO₂ | 30 | A | 30.5 | 18 | 3,500 | 0.0600 | 21.0 | 6.4 | 35 |
| h-28 | Invention | DPHA | — | — | SiO₂ | 30 | A | 30.5 | 18 | 3,500 | 0.1200 | 42.0 | 12.8 | 35 |
| h-29 | Comparison | DPHA | — | — | SiO₂ | 30 | A | 30.5 | 18 | 3,500 | 0.2400 | 84.0 | 25.6 | 35 |
| h-30 | Invention | DPHA | — | — | SiO₂ | 10 | A | 30.5 | 18 | 3,500 | 0.0200 | 7.0 | 2.1 | 35 |
| h-31 | Invention | DPHA | — | — | SiO₂ | 3 | A | 30.5 | 18 | 3,500 | 0.0200 | 7.0 | 2.1 | 35 |
| h-32 | Invention | DPHA | — | — | SiO₂ | 40 | A | 30.5 | 18 | 3,500 | 0.0200 | 7.0 | 2.1 | 35 |
| h-33 | Invention | TMPTA | — | — | SiO₂ | 30 | A | 30.5 | 18 | 3,500 | 0.0200 | 7.0 | 2.1 | 35 |
| h-34 | Invention | BDDA | — | — | SiO₂ | 30 | A | 30.5 | 18 | 3,500 | 0.0200 | 7.0 | 2.1 | 35 |
| h-35 | Invention | Com- | — | — | SiO₂ | 30 | A | 30.5 | 18 | 3,500 | 0.0200 | 7.0 | 2.1 | 35 |
| | | pound | | | | | | | | | | | | |
| | | A-1 | | | | | | | | | | | | |
| h-36 | Invention | DPHA | — | — | TiO₂ | 30 | A | 30.5 | 18 | 3,500 | 0.0200 | 7.0 | 2.1 | 35 |

| Hard Coat | | Layer | Antifouling | Antifouling Property |
|---|---|---|---|---|
| Solution | Remarks | Thickness (μm) | Property | after wiping |
| h-1 | Comparison | 35 | D | D |
| h-2 | Invention | 35 | A | A |
| h-3 | Invention | 35 | A | A |
| h-4 | Invention | 35 | A | A |
| h-5 | Invention | 35 | A | A |
| h-6 | Invention | 35 | A | A |
| h-7 | Invention | 35 | A | A |
| h-8 | Invention | 17 | A | A |
| h-9 | Invention | 8 | A | A |
| h-10 | Invention | 8 | A | A |
| h-11 | Invention | 8 | A | A |
| h-12 | Invention | 35 | A | A |
| h-13 | Comparison | 35 | B | D |
| h-14 | Comparison | 35 | D | D |
| h-15 | Invention | 35 | A | A |
| h-16 | Invention | 35 | A | A |
| h-17 | Invention | 35 | A | A |
| h-18 | Invention | 35 | A | A |
| h-19 | Comparison | 35 | B | D |
| h-20 | Comparison | 35 | B | D |
| h-21 | Comparison | 35 | B | D |
| h-22 | Comparison | 35 | D | D |
| h-23 | Invention | 35 | B | B |
| h-24 | Invention | 35 | B | C |
| h-25 | Comparison | 35 | D | D |
| h-26 | Comparison | 35 | D | D |
| h-27 | Invention | 35 | A | A |
| h-28 | Invention | 35 | A | A |
| h-29 | Comparison | 35 | A | A |
| h-30 | Invention | 35 | A | A |
| h-31 | Invention | 35 | A | A |
| h-32 | Invention | 35 | A | A |
| h-33 | Invention | 35 | A | A |
| h-34 | Invention | 35 | A | A |
| h-35 | Invention | 35 | A | A |
| h-36 | Invention | 35 | A | A |

In Table 4, DPHA means dipentaerythritol hexaacrylate and BDDA means butanediol acrylate. “Compound A-1” in h-35 is P-1 in Table 1 having a weight average molecular weight of 20,000.

Comparative Compound E of epoxy monomer, structure A and structure B of antifouling agent are shown below. In the following structures A and B of antifouling agent, R represents a —(CH₂)₄—O—CO—CH═CH₂ group.

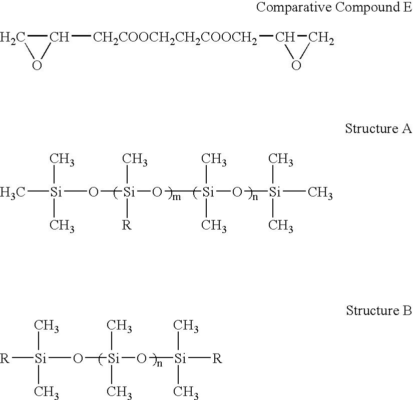

Acrylic substitution ratio in Table 4 means the rate that the methyl group in the antifouling agent of structure A or B is substituted with alkyl group R having a methacrylic group, specifically represented by [{(total number of R)/(total number of the methyl groups+total number of R)}×100].

1-2. Coating on Wooden Base Material

As a wooden base material, a base material comprising plywood laminated with a decorative wooden veneer was used, and the surface to be hard coat processed was polished with a sand paper to be smoothed. An aqueous varnish was coated on the polished surface with a spray gun in a thickness of 5 μm and dried in the air (primer treatment). Subsequently, hard coat solution of each sample shown in Table 4 was coated on the part coated with aqueous varnish in the coating amount of the antifouling agent (coating amounts of silicone compound (Si compound) and Si atom) as shown in Table 4.

The coated solution was then dried at 80° C. for 5 minutes, and irradiated with UV ray (700 mJ/cm²) under the nitrogen atmosphere (oxygen concentration: 0.3%), whereby a hard coat processed product the surface of which was covered with a hard coat layer having a thickness of 35 μm was obtained. The film thickness of each of h-8 to h-11 was adjusted by reducing the coating amount of each hard coat layer coating solution.

1-3. Evaluation

Each hard coat processed product prepared was evaluated by the following test methods. The results obtained are shown in Table 4.

(1) Antifouling Property

The mark written with quick drying oil ink (“Mckee”, registered trademark, manufactured by ZEBRA CO., LTD.) on the surface of each hard coat processed product was wiped by rubbing several times with “Toraysee” (registered trademark, manufactured by Toray Industries Inc.), and this state of the hard coat processed product was evaluated.
A: The written mark was completely wiped off.
B: The mark was wiped off almost but a slight trace was left.
C: A part of the mark could not be wiped and left.
D: Almost all the mark was left after wiping.
   (2) Antifouling Property After Wiping

The state after repeating writing and wiping 20 times at the same place was evaluated in the same manner.

### Example 2

The hard coating articles prepared in Example 1 were evaluated as follows. The results obtained are shown in Table 5 below.

(1) Pencil Hardness Test

Each hard coat processed product was subjected to humidity conditioning at 25° C. 60% RH or 2 hours, and pencil hard test was performed using 3H pencil for the test prescribed by JIS-S-6006 with a load of 9.8 N according to the evaluation method of pencil hardness in JIS-K-5400.
A: Scratch was not observed.
B: Scratch was a little observed.
C: Scratch was observed.
   (2) Scratch Resistance

The surface of each sample was rubbed with #0000 steel wool by applying a load of 1.96 N/cm² until the scratch could be visually observed.
A: Scratch could not be observed by rubbing 300 times.
B: Scratch was observed slightly.
C: Scratch was observed but not until 100 times.

D: Scratch was observed by rubbing less than 100 times.

TABLE 5

| Hard | | Layer | | |
|---|---|---|---|---|
| Coat | | Thickness | Pencil | Scratch |
| Solution | Remarks | (μm) | Hardness | Resistance |
| h-1 | Comparison | 35 | A | B |
| h-2 | Invention | 35 | A | B |
| h-3 | Invention | 35 | B | C |
| h-4 | Invention | 35 | B | C |
| h-5 | Invention | 35 | A | B |
| h-6 | Invention | 35 | A | B |
| h-7 | Invention | 35 | B | C |
| h-8 | Invention | 17 | B | C |
| h-9 | Invention | 8 | C | D |
| h-10 | Invention | 8 | B | C |
| h-11 | Invention | 8 | A | B |
| h-12 | Invention | 35 | C | D |
| h-13 | Comparison | 35 | A | B |
| h-14 | Comparison | 35 | A | B |
| h-15 | Invention | 35 | A | B |
| h-16 | Invention | 35 | B | C |
| h-17 | Invention | 35 | C | D |
| h-18 | Invention | 35 | A | A |
| h-19 | Comparison | 35 | A | A |
| h-20 | Comparison | 35 | A | A |
| h-21 | Comparison | 35 | A | A |
| h-22 | Comparison | 35 | A | A |
| h-23 | Invention | 35 | A | A |
| h-24 | Invention | 35 | A | A |
| h-25 | Comparison | 35 | A | A |
| h-26 | Comparison | 35 | A | A |
| h-27 | Invention | 35 | A | A |
| h-28 | Invention | 35 | A | A |
| h-29 | Comparison | 35 | A | A |
| h-30 | Invention | 35 | B | B |
| h-31 | Invention | 35 | B | C |
| h-32 | Invention | 35 | B | C |
| h-33 | Invention | 35 | A | B |
| h-34 | Invention | 35 | C | D |
| h-35 | Invention | 35 | A | B |
| h-36 | Invention | 35 | B | B |

### Example 3

Manufacture of Hard Coat Film:

3-1. Coating on Film

Both surfaces of a PET (a biaxially stretched polyethylene terephthalate film) having a thickness of 250 μm were subjected corona treatment. A latex comprising a copolymer of styrene-butadiene having a refractive index of 1.55 and glass transition temperature of 37° C. (LX 407C5, manufactured by Nippon Zeon Co., Ltd.) was mixed with a compound oxide of tin oxide and antimony oxide (FS-10D, manufactured by Ishihara Sangyo Kaisha Ltd.) in weight ratio of 5/5, and the mixture was coated on the surface to be provided with a hard coat layer of the above film in a dry thickness of 200 nm, thus an undercoat layer having an antifouling layer was formed, and then the hard coat solution prepared in Example 1 was coated thereon by extrusion coating in the coating amount of the antifouling agent (coating amounts of silicone compound (Si compound) and Si atom) as shown in Table 6. The coated solution was then dried and irradiated with UV ray (700 mJ/cm²) under the nitrogen atmosphere (oxygen concentration: 0.1%), wherebyahardcoat filmhavinga thickness shown in Table 6 was obtained.

3-2. Evaluation

With the hard coat film, pencil hardness, scratch resistance and anti fouling property were evaluated in the same manner as in Example 1. The brittleness and surface contition were evaluated as shown below. The results obtained are shown in Table 6 below.

(1) Brittleness

The diameter of curvature of generating cracking was obtained when a hard coat film was rolled up with the hard coat layer coated side outside.
A: Cracking did not occur by 20 mm or less.
C: Cracking occurred by 50 mm or less.
B: Others.
   (2) Surface Condition

The surface condition of the area of 15 cm×15 cm was visually observed.
A: No defect was confirmed.
C: Three or more defects were observed.

B: Others.

TABLE 6

| Hard | | Si Compound | Si Atom | Layer | | | | Antifouling | | |
|---|---|---|---|---|---|---|---|---|---|---|
| Coat | | Coating Amount | Coating Amount | Thickness | Pencil | Scratch | Antifouling | Property | | Surface |
| Solution | Remarks | (mg/m²) | (mg/m²) | (μm) | Hardness | Resistance | Property | after Wiping | Brittleness | Condition |
| h-1 | Comp. | 0.0 | 0.0 | 20 | A | B | D | D | A | A |
| h-2 | Inv. | 4.0 | 1.2 | 20 | A | B | A | A | A | A |
| h-3 | Inv. | 4.0 | 1.2 | 20 | B | C | A | A | A | A |
| h-4 | Inv. | 4.0 | 1.2 | 20 | B | C | A | A | A | A |
| h-5 | Inv. | 4.0 | 1.2 | 20 | A | B | A | A | B | A |
| h-6 | Inv. | 4.0 | 1.2 | 20 | A | B | A | A | B | A |
| h-7 | Inv. | 4.0 | 1.2 | 20 | B | C | A | A | C | A |
| h-8 | Inv. | 2.0 | 0.6 | 10 | B | C | A | A | B | A |
| h-9 | Inv. | 1.0 | 0.3 | 5 | C | D | A | A | A | A |
| h-10 | Inv. | 1.0 | 0.3 | 5 | B | C | A | A | A | A |
| h-11 | Inv. | 1.0 | 0.3 | 5 | A | B | A | A | A | A |
| h-12 | Inv. | 4.0 | 1.2 | 20 | C | D | A | A | A | A |
| h-13 | Comp. | 4.0 | 1.5 | 20 | A | B | B | D | A | C |
| h-14 | Comp. | 4.0 | 0.7 | 20 | A | B | D | D | A | A |
| h-15 | Inv. | 4.0 | 1.2 | 20 | A | B | A | A | A | A |
| h-16 | Inv. | 4.0 | 1.2 | 20 | B | C | A | A | A | A |
| h-17 | Inv. | 4.0 | 1.2 | 20 | C | D | A | A | B | A |
| h-18 | Inv. | 4.0 | 1.2 | 20 | A | A | A | A | A | A |
| h-19 | Comp. | 4.0 | 1.4 | 20 | A | A | B | D | A | C |
| h-20 | Comp. | 4.0 | 1.4 | 20 | A | A | B | D | A | A |
| h-21 | Comp. | 4.0 | 1.5 | 20 | A | A | B | D | A | C |
| h-22 | Comp. | 4.0 | 0.7 | 20 | A | A | D | D | A | A |
| h-23 | Inv. | 1.6 | 0.5 | 20 | A | A | B | B | A | A |
| h-24 | Inv. | 0.6 | 0.2 | 20 | A | A | B | C | A | A |
| h-25 | Comp. | 0.2 | 0.1 | 20 | A | A | D | D | A | A |
| h-26 | Comp. | 0.0 | 0.0 | 20 | A | A | D | D | A | A |
| h-27 | Inv. | 12.0 | 3.7 | 20 | A | A | A | A | A | A |
| h-28 | Inv. | 24.0 | 7.3 | 20 | A | A | A | A | A | B |
| h-29 | Comp. | 48.0 | 14.6 | 20 | A | A | A | A | A | C |
| h-30 | Inv. | 4.0 | 1.2 | 20 | B | B | A | A | A | A |
| h-31 | Inv. | 4.0 | 1.2 | 20 | B | C | A | A | A | A |
| h-32 | Inv. | 4.0 | 1.2 | 20 | B | C | A | A | A | A |
| h-33 | Inv. | 4.0 | 1.2 | 20 | A | B | A | A | A | A |
| h-34 | Inv. | 4.0 | 1.2 | 20 | C | D | A | A | A | A |
| h-35 | Inv. | 4.0 | 1.2 | 20 | A | B | A | A | A | A |
| h-36 | Inv. | 4.0 | 1.2 | 20 | B | B | A | A | A | A |

The following facts are seen from the results of Examples 1 to 3 (Tables 4 to 6).

a. The Effect of the Addition of Antifouling Agent (the Effect of the Addition of Silicone Resin)

h-2 and h-18, which were respectively corresponding to h-1 and h-26, to which the antifouling agent of the invention was added, were excellent in antifouling property after wiping.

b. The Influence of Si Content in the Antifouling Agent

h-13 and h-19, 20 and 21 obtained by the addition of the antifouling agent having a high Si content to h-2 and h-18 showed an antifouling property at initial stage but the antifouling property lowered after being wiped. Further, minute concavities and convexities were generated on the surface of the film, so that not preferred.

On the other hand, h-14 and h-22 to which the antifouling agent having a low Si content was added did not show an antifouling property from the first.

c. The Influence of the Addition Amount of the Antifouling Agent

When the addition amount of the antifouling agent to h-18 was increased as in h-27, 28 and 29, minute concavities and convexities were generated on the surface of the film, so that not preferred.

d. The Influence of the Addition Amount of the Epoxy Monomer (the Effect of the curing Resin Containing Ring-Opening Polymerizable Groups)

When the addition amount of the epoxy monomer to h-2 was decreased as in h-5, 6 and 7, brittleness resistance was deteriorated. While when the amount was increased as in h-3 and 4, too much an amount resulted in the deterioration of hardness and scratch resistance.

e. The Effect of Film Thickness

The deterioration of brittleness resistance as in h-6 could be improved by reducing the layer thickness as in h-8 and 9, but hardness and scratch resistance lowered. Therefore, it can be seen that epoxy monomer is useful to the compatibility of brittleness resistance and hardness.

f. The Influence of the Kind of Acrylic Monomer (the Effect of the Curing Resin Containing Ethylenically Unsaturated Groups)

When the kinds of acryli monomer were changed as h-12 to h-2, or h-33 and 34 to h-18, the hardness was influenced. The case where the compounds having three or more functional groups in the same molecule (TMPTA, DPHA and A-1) were used was superior to the case where BDDA having only two functional groups in the same molecule in the hardness and scratch resistance.

### Example 4

Sticking of Hard Coat Film on Liquid Display:

4-1. Formation of Adhesive Layer

An acrylic copolymer (solvent: ethyl acetate/toluene: 1/1) and an isocyanate crosslinking agent (solvent: ethyl acetate/toluene: 1/1) were mixed in a ratio of 100/1 (by weight) to prepare adhesive coating solution A. An adhesive layer was provided on the surface of the releasable film by the indirect method using adhesive coating solution A.

With transferring a polyethylene releasable film wound in to a roll, adhesive coating solution A was coated on the surface of the releasable film in a dry thickness of 20 μm. The film was then dried in a drying zone at 100° C., thus a releasable film having an adhesive layer was obtained.

4-2. Sticking on Liquid Display

The above-obtained adhesive was transferred to the surface not having a hard coat layer of the hard coat film prepared in Example 2, and the film was stuck on a liquid display.

4-3. Evaluation

The scratch resistance and the antifouling property of the surface of the liquid display prepared were evaluated in the same manner as in Example 1. The same tendencies as in Example 1 were obtained. The results are shown in Table 7below.

TABLE 7

| Hard | | Layer | | | | Antifouling |
|---|---|---|---|---|---|---|
| Coat | | Thickness | Pencil | Scratch | Antifouling | Property |
| Solution | Remarks | (μ) | Hardness | Resistance | Property | after Wiping |
| h-1 | Comparison | 20 | A | B | D | D |
| h-2 | Invention | 20 | A | B | A | A |
| h-3 | Invention | 20 | B | C | A | A |
| h-4 | Invention | 20 | B | C | A | A |
| h-5 | Invention | 20 | A | B | A | A |
| h-6 | Invention | 20 | A | B | A | A |
| h-7 | Invention | 20 | B | C | A | A |
| h-8 | Invention | 10 | B | C | A | A |
| h-9 | Invention | 5 | C | D | A | A |
| h-10 | Invention | 5 | B | C | A | A |
| h-11 | Invention | 5 | A | B | A | A |
| h-12 | Invention | 20 | C | D | A | A |
| h-13 | Comparison | 20 | A | B | B | D |
| h-14 | Comparison | 20 | A | B | D | D |
| h-15 | Invention | 20 | A | B | A | A |
| h-16 | Invention | 20 | B | C | A | A |
| h-17 | Invention | 20 | C | D | A | A |
| h-18 | Invention | 20 | A | A | A | A |
| h-19 | Comparison | 20 | A | A | B | D |
| h-20 | Comparison | 20 | A | A | B | D |
| h-21 | Comparison | 20 | A | A | B | D |
| h-22 | Comparison | 20 | A | A | D | D |
| h-23 | Invention | 20 | A | A | B | B |
| h-24 | Invention | 20 | A | A | B | C |
| h-25 | Comparison | 20 | A | A | D | D |
| h-26 | Comparison | 20 | A | A | D | D |
| h-27 | Invention | 20 | A | A | A | A |
| h-28 | Invention | 20 | A | A | A | A |
| h-29 | Comparison | 20 | A | A | A | A |
| h-30 | Invention | 20 | B | B | A | A |
| h-31 | Invention | 20 | B | C | A | A |
| h-32 | Invention | 20 | B | C | A | A |
| h-33 | Invention | 20 | A | B | A | A |
| h-34 | Invention | 20 | C | D | A | A |
| h-35 | Invention | 20 | A | B | A | A |
| h-36 | Invention | 20 | C | B | A | A |

### Example 5

Manufacture of Optical Information Recording Media:

5-1. Manufacture of Substrate and Recording Layer

Ag was sputtered on the surface having grooves of a base material of an injection molded polycarbonate resin having spiral grooves (depth: 100 nm, breadth 120 nm, track pitch: 320 nm), a thickness of 1.1 mm and a diameter of 120 mm (Panlite AD5503, trade name, manufactured by Teijin), whereby a light reflecting layer having a thickness of 100 nm was formed.

A recording layer coating solution was prepared by adding 20 g of Orazoleble GN (recording material 1, phthalocyanine dye, manufactured by Ciba Chemical Specialty Chemicals Inc.) to one liter of 2,2,3,3-tetrafluoropropanol, and dissolving the mixture by ultrasonic wave treatment for 2 hours. The obtained coating solution was coated by spin coating on the light reflecting layer by changing the rotation speed from 300 to 4,000 rpm on the condition of 23° C. 50% RH. The coated recording layer was allowed to stand at 23° C. 50% RH for 1 to 4 hours, the thickness of the thus-formed recording layer was 100 nm. ZnS-SiO₂ was sputtered in a thickness of 5 nm on the recording layer, whereby an intermediate layer (a barrier layer) was formed.

5-2. Formation of Hard Coat Film Base

(1) Manufacture of Cellulose Acylate Film (TAC)

Both terminal dihydroxy polyester having an average molecular weight of 2,125 comprising adipic acid having a repeating unit of —[O—(CH₂)₂—OOC—(CH₂)₄—CO]— and ethylene glycol was processed with tolylenediisocyanate (TDI) and polyester-urethane resin having an average molecular weight of 7,300 soluble in methylene chloride was synthesized. The compound was designated PU-1. A dope having the following composition was obtained by adding cellulose acetate to PU-1.

| | |
|---|---|
| Cellulose triacetate | 100 weight parts |
| PU-1 | 15 weight parts |
| Methylene chloride | 270 weight parts |
| Butanol | 7 weight parts |
| Methanol | 70 weight parts |
| Triazine | 9 weight parts |

The composition was put in a closed vessel and thoroughly dissolved by stirring under pressure with maintaining the temperature at 80° C. The dope was then filtered, cooled to 25° C., and cast on a rotating drum having a diameter of 30 cm equipped with a jacket while maintaining the temperature at 25° C. From the necessity of serving for heat transfer, corrosion resistance and plane property, an Ni layer having a thickness of about 50 μm was plated on the SB material of the drum, further, hard chromium of about 40 μm was plated on the surface two times, and the surface was further subjected to hyper smooth mirror polishing of from 0.01 to 0.05 S. At this time, the surface temperature of the drum was maintained at 0° C. by circulating chilled water through the jacket. The casting rate was fixed at 3 m/min, a film was stripped via a stripping roll at a rate of 3.15 m/min at the position 270° turned from the casting position to the casting direction, and 5% was cast to the casting direction. The both sides of the stripped base were fixed, dried by hot air at 70° C., thus a film having a thickness of 80 μm was obtained. The moisture expansion coefficient by the change of humidity was 40 ppm/% RH from the measurement of the film lengths.

(2) Manufacture of Cyclic Polyolefin Film (OLE)

A cyclic olefin resin (glass transition temperature 98° C., the temperature of 5% loss on heating: 360° C.), which was obtained by the hydrogenation of a ring-opening copolymer of dicyclopentadiene/tetracyclododecene, was heated to melt in a kneader at 180° C., whereby a molten resin was obtained. Each roll of 8-inch inverted L four-roll calender was set at 190° C., and the above molten resin was let into the nip between the rolls in sequence, and stripped from the rolls in the last place, cooled, thus a cyclic polyolefin film having a thickness of 80 μm was obtained. The moisture expansion coefficient of the film was 9 ppm/% RH.

5-3. Manufacture of Hard Coat Film (Coating of Hard Coat Layer)

A latex comprising a styrene/butadiene copolymer having a refractive index of 1.55 and glass transition temperature of 37° C. (LX 407C5, manufactured by Nippon Zeon Co., Ltd.) was mixed with a compound oxide of tin oxide and antimony oxide (FS-10D, manufactured by Ishihara Sangyo Kaisha Ltd.) in weight ratio of 5/5, and the mixture was coated on the surface to be provided with a hard coat layer of the cellulose acylate film manufactured above having a thickness of 80 μm, the cyclic polyolefin film having a thickness of 80 μm both surfaces of which were subjected to corona treatment, and a polycarbonate film (PC) (Teijin Pure Ace, thickness: 75 μm, with a releasable film on one side, a moisture expansion coefficient: 12 ppm/% RH) in a dry thickness of 200 nm, thus an undercoat layer having an antifouling layer was formed, and then the hard coat solution prepared in Example 1 was coated thereon by extrusion coating in a dry thickness of the hard coat layer of 5 μm. The coated solution was then dried and irradiated with UV ray (700 mJ/cm²) under the nitrogen atmosphere, whereby a hard coat film was obtained, and wound into a roll.

5-4. Sticking of Hard Coat Film and Substrate Disc

An optical information recording media was manufactured in the following manner by sticking the hard coat film prepared in the above 5-3 on the recording layer prepared in the above 5-1 through an intermediate layer.

(1) Formation of Adhesive Layer

An acrylic copolymer (solvent: ethyl acetate/toluene: 1/1) and an isocyanate crosslinking agent (solvent: ethyl acetate/toluene: 1/1) were mixed in a ratio of 100/1 (by weight) to prepare adhesive coating solution A. An adhesive layer was provided on the surface of the releasable film by the indirect method using adhesive coating solution A.

With transferring a polyethylene releasable film wound into a roll, adhesive coating solution A was coated on the surface of the releasable film in a dry thickness of 20 μm. The film was then dried in a drying zone at 100° C., thus a releasable film having an adhesive layer was obtained.

(2) Manufacture of Transparent Sheet for Optical Information Recording Media

The above-obtained releasable film having an adhesive layer was stuck on the surface opposite to the side having a hard coat layer of the hard coat film so that the adhesive layer came to touch the surface. Thereafter, the hard coat film provided with a hard coat layer and an adhesive layer was wound into a roll again, and allowed to stand at 23° C. 50% RH for 72 hours in that state.

The hard coat film having the total thickness of the hard coat layer, the adhesive layer and the base film of 100 to 105 μm was delivered and punched in the same shape as the substrate, whereby a transparent sheet for an optical information recording media having an adhesive layer on one side of the light transmitting film and a hard coat layer on the other side was obtained.

(3) Manufacture of Optical Information Recording Media (Sticking of Hard Coat Film to Substrate, Recording Layer)

The releasable film on the adhesive side was peeled from the disc-like transparent sheet for an optical information recording media, and the intermediate layer and the adhesive layer were stuck by pressing means using a roller to prepare an optical information recording media.

5-5. Measurement of Recording Characteristics

17LL modulation signals were recorded and reproduced using the sample manufactured and recording and reproducing device DDU1000 (manufactured by Pulse Tech Co.) having a pickup consisting of a bluish violet laser emitting at λ=405 nm and an object lens having numerical aperture NA 0.85, and jitter in signal reproduction was measured with a time interval analyzer.

Further, the following processes were carried out and the increment of jitter before and after each process was obtained: (i) after preserving the sample on the condition of 80° C. 80% RH for 7 days, (ii) after rubbing the surface of the light-transmitting layer with #0000 steel wool by applying a load of 1.96 N/cm², and (iii) after wiping the mark on the surface of the light-transmitting layer written with quick drying oil ink (“Mckee”, registered trademark, manufactured by ZEBRA CO., LTD.) by rubbing several times with “Toraysee” (registered trademark, manufactured by Toray Industries Inc.). (“A” state in which the increment of jitter is less than 1%, “B” state in which the increment of jitter is 1% or more and less than 3%, “C” state in which the increment of jitter is 3% or more and less than 5%, and “D” state in which the increment of jitter is 5% or more.) Optical information recording medias manufactured and the results of various measurements are shown in Table 8 below.

TABLE 8

| | | | | Reading Characteristics | | | |
|---|---|---|---|---|---|---|---|
| | | | | Fresh | Increase | Increase | |
| Run | Hard Coat | | Film | (before | after | after | Increase |
| No. | Solution | Remarks | Base | process) | Storage | Scratching | after Writing |
| 1 | h-1 | Comparison | PC | B | B | B | D |
| 2 | h-2 | Invention | PC | B | B | B | A |
| 3 | h-3 | Invention | PC | B | B | C | A |
| 4 | h-4 | Invention | PC | B | B | C | A |
| 5 | h-5 | Invention | PC | B | B | B | A |
| 6 | h-6 | Invention | PC | B | B | B | A |
| 7 | h-7 | Invention | PC | B | B | C | A |
| 8 | h-12 | Invention | PC | B | C | D | A |
| 9 | h-13 | Comparison | PC | D | — | — | — |
| 10 | h-14 | Comparison | PC | B | B | B | D |
| 11 | h-15 | Invention | PC | B | B | B | A |
| 12 | h-16 | Invention | PC | B | B | C | A |
| 13 | h-17 | Invention | PC | B | B | D | A |
| 14 | h-18 | Invention | PC | B | B | A | A |
| 15 | h-19 | Comparison | PC | C | B | A | D |
| 16 | h-20 | Comparison | PC | B | B | A | D |
| 17 | h-21 | Comparison | PC | D | — | — | — |
| 18 | h-22 | Comparison | PC | B | B | A | D |
| 19 | h-23 | Invention | PC | B | B | A | B |
| 20 | h-24 | Invention | PC | B | B | A | C |
| 21 | h-25 | Comparison | PC | B | B | A | D |
| 22 | h-26 | Comparison | PC | B | B | A | D |
| 23 | h-27 | Invention | PC | B | B | A | A |
| 24 | h-28 | Invention | PC | B | B | A | A |
| 25 | h-29 | Comparison | PC | D | — | — | — |
| 26 | h-30 | Invention | PC | B | B | B | A |
| 27 | h-31 | Invention | PC | B | B | C | A |
| 28 | h-32 | Invention | PC | B | B | C | A |
| 29 | h-33 | Invention | PC | B | B | B | A |
| 30 | h-34 | Invention | PC | B | B | D | A |
| 31 | h-35 | Invention | PC | B | B | B | A |
| 32 | h-36 | Invention | PC | B | B | B | A |
| 33 | h-2 | Invention | TAC | B | D | B | A |
| 34 | h-2 | Invention | OLE | B | C | B | A |
| 35 | h-18 | Invention | TAC | B | D | A | A |
| 36 | h-18 | Invention | OLE | B | C | A | A |

From the results in Table 8, the degrees of the reduction of reading characteristics after scratching and writing with the ink were almost coincided with those in Examples 1 to 4.

On the other hand, the degree of the reduction of reading characteristics after preservation was great in the case where the film base other than polycarbonate (PC) was used, and polycarbonate was most preferred. Further, Run Nos. 9, 17 and 25 in which Si content in the antifouling agent or the antifouling agent was great were inferior in reading characteristics from the initial stage.

As another example of the material of recording layer, the material was manufactured using DC and RF sputtering in place of Orazoleble GN, and forming a film form lamination layer comprising AgPdCu/ZnSSiO/AgInSeTe/ZnSSiO (recording material 2) as the material for phase change recording.

Optical information recording medias (Run No. 37 to 39) were manufactured by changing each recording material of Run Nos. 18, 22 and 26 to the above recording material 2, and the same evaluation was performed. The similar results to those of Run Nos. 18, 22 and 26 were obtained.

This application is based on Japanese Patent Application No. JP2003-347111 filed on October 6, 2003, the contents of which is incorporated herein by reference.

### INDUSTRIAL APPLICABILITY

The hard coating articles according to the invention can be used as displays and touch panels of CRT, LCD, PDP and FED, windows of buildings and vehicles, wall materials capable of the prevention of scribblings and sticking of bills, tables, decorative plywood, etc., and they are particularly preferred as the surface protective films of optical information recording medias, e.g., CD, DVD and Blu-ray Disc.

1. An article comprising a base material and at least one hard coat layer, the at least one hard coat layer comprising an outer most layer of the article,
wherein the outermost layer comprises a cured film formed by coating and curing a curing composition comprising an actinic energy-curing resin, wherein the actinic energy-curing resin comprises a silicone resin having a silicon content of from 23 to 32 weight %; and a coating amount of the silicone resin is from 0.4 to 45 mg/m².

2. The article as claimed in claim 1, wherein the actinic energy-curing resin further comprises a first curing resin having a first molecule, the first molecule having three or more ethylenically unsaturated groups.

3. The article as claimed in claim 1, wherein the actinic energy-curing resin further comprises: a first curing resin having a first molecule, the first molecule having three or more ethylenically unsaturated groups; and a second curing resin having a second molecule, the second molecule having three or more ring-opening polymerizable groups in, and
the actinic energy-curing resin has a content of the second resin from 5 to 40 weight % to the total content of the first resin and the second resin.

4. The article as claimed in claim 3, wherein the second curing resin is a crosslinkable polymer having a repeating unit represented by formula (1): 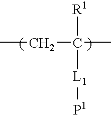
wherein R¹ represents a hydrogen atom or an alkyl group having from 1 to 4 carbon atoms; P¹ represents a monovalent group having a ring-opening polymerizable group; and L¹ represents a single bond or a divalent linking group.

5. The article as claimed in claim 3, wherein the three or more ring-opening polymerizable groups comprise a cationic polymerizable group.

6. The article as claimed in claim 1, wherein the silicone resin is a polydimethylsiloxane represented by formula (a): 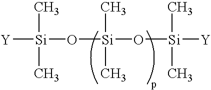
wherein Y represents a hydrogen atom, a methyl group, a hydroxyl group or a methoxy group; p represents an integer of from 10 to 1,500; and 10 to 25% methyl groups are substituted with a alkyl group having a (meth) acrylate group.

7. The article as claimed in claim 1, wherein the curing composition comprises a particulate filler of 5 to 35 weight parts to 100 weight parts in total of the actinic energy-curing resin.

8. The article as claimed in claim 1, wherein the hard coat layer is a single layer.

9. A curing composition, which comprises an actinic energy-curing resin comprising a silicon resin of from, 0.001 to 0.2 weight % to the total amount of the actinic energy-curing resin, wherein the silicon resin has a silicon content of from 23 to 32 weight %.

10. An article comprising a base material and at least one hard coat layer, the at least one hard coat layer comprising an outermost layer of the article,
wherein the outmost layer comprises a cured film formed by coating and curing a curing composition as claimed in claim 9 on the base material.

11. The article as claimed in claim 10, wherein the base material is a film having a thickness of from 20 to 300 μm.

12. An information recording media capable of reproducing an information signal by an optical means, which comprises: a substrate; a recording layer capable of recording the information signal; and a light-transmitting layer capable of transmitting a light in this order,
wherein the light-transmitting layer is an article as claims in claim 1.

13. The information recording media as claimed in claim 12, wherein the base material is a polycarbonate film having a thickness of from 20 to 300 μm, and the light transmitting layer has a thickness of from 50 to 300 μm.

14. The article as claimed in claim 1, wherein the base material is a film having a thickness of from 20 to 300 μm.

15. An information recording media capable of reproducing an information signal by an optical means, which comprises: a substrate; a recording layer capable of recording the information signal; and a light-transmitting layer capable of transmitting a light in this order,
wherein the light-transmitting layer is an article comprising a base material and at least one hard coat layer, the at least one hard coat layer comprising an outermost layer of the article,
the outermost layer comprises a cured film formed by coating and curing a curing composition, and
the curing composition comprises an actinic energy-curing resin comprising a silicon resin of from, 0.001 to 0.2 weight % to the total amount of the actinic energy-curing resin, wherein the silicon resin has a silicon content of from 23 to 32 weight %.
